(19) United States
(12) Patent Application Publication
(10) Pub. No.: US 2011/0032615 A1
(43) Pub. Date: Feb. 10, 2011

(54) LENS BARREL, METHOD OF ADJUSTING LENS BARREL, METHOD OF MANUFACTURING LENS BARREL AND IMAGING DEVICE

(75) Inventors: Kazutoshi USUI, Kawasaki-shi (JP); Takeshi SUZUKI, Yokohama-shi (JP); Nobutaka HIRAMA, Saitama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/838,886

(22) Filed: Jul. 19, 2010

Related U.S. Application Data
(63) Continuation of application No. PCT/JP2009/050939, filed on Jan. 22, 2009.

(30) Foreign Application Priority Data
Jan. 22, 2008 (JP) 2008-011469
Jan. 22, 2008 (JP) 2008-011472
Jul. 17, 2008 (JP) 2008-186297
Dec. 25, 2008 (JP) 2008-331265

(51) Int. Cl. G02B 27/64; G02B 7/04

(52) U.S. Cl. 359/554; 359/823

(57) ABSTRACT

This object aims to provide a lens barrel that can realize suitable imaging. A lens barrel (100) is characterized in including an imaging optical system (102, 104) having a second optical system (102) that is relatively movable against a first optical system (104) and a driving unit (113) for driving the second optical system (102) relatively to the first optical system (104) so that an aberration of the imaging optical system (102, 104) can be reduced.

### TECHNICAL FIELD

The present invention relates to a lens barrel, a method of adjusting a lens barrel, a method of manufacturing a lens barrel, and an imaging device.

### BACKGROUND ART

Recently, the demand for higher performance and higher magnification for an optical device such as a lens barrel of a camera has been increasing. With such demands becoming high, it becomes difficult to realize such high demand even if components such as the lens and the like for configuring a lens barrel and the accuracy for assembly thereof are improved. Thus, in order to improve optical performance, alignment for making an eccentric component such as lenses configuring a lens barrel correspond to an optical axis is performed when assembling the lens barrel assembling (for example, see Japanese Unexamined Application Publication No. 2003-43328).

### DISCLOSURE OF THE INVENTION

### Problems to be Solved by the Invention

However, a conventional alignment is performed when a position of a lens barrel is in a normal position (a position of a camera when a user captures a horizontally long image with an optical axis being horizontal). Thus, there is a problem in that, when changing a position of the lens barrel from a normal position to another position to take an image, eccentricity occurs to each lens in a lens barrel, such that aberration arises, thereby it causing deterioration of imaging performance.

Furthermore, in a case of a zoom lens, since eccentric components are also changed as a focusing distance is altered, alignment is required according to a focusing distance; however, it is difficult to perform alignment for each zoom position.

Thus, aberration arises according to a focusing distance, whereby it is difficult to obtain higher imaging performance.

It is an object of the present invention to provide a lens barrel, a method of adjusting a lens barrel, a manufacturing method of a lens barrel, and an imaging device that can realize preferred imaging.

### Means for Solving the Problems

The present invention solves the above-mentioned object by way of the following means.

An invention described in claim 1 is a lens barrel comprising: an imaging optical system having a second optical system that can be moved relative to a first optical system; and drive unit that causes the second optical system to be driven relative to the first optical system so that aberration of the imaging optical system is reduced, after detecting a focusing distance of the imaging optical system and before capturing an image by way of the imaging optical system.

An invention described in claim 2 is a lens barrel comprising: an imaging optical system having a second optical system that can be moved relative to a first optical system; and a drive unit that causes the second optical system to be driven relative to the first optical system so that aberration of the imaging optical system is reduced, after detecting an attitude at the time of image capturing and before capturing an image by way of the imaging optical system.

An invention described in claim 3 is the lens barrel according to claim 1 or 2, wherein the drive unit drives the second optical system in a direction that intersects with an optical axis of the imaging optical system.

An invention described in claim 4 is the lens barrel according to claim 1 or 2, wherein the drive unit drives the second optical system so as to be inclined relative to the first optical system.

An invention described in claim 5 is the lens barrel according to any one of claims 1 to 4, comprising: a storage unit that can store position information of the second optical system in which an aberration amount of the imaging optical system is suppressed, wherein: the drive unit drives the second optical system based on position information stored in the storage unit.

An invention described in claim 6 is the lens barrel according to claim 5, wherein: the storage unit stores position information of the second optical system according to a focusing distance of the imaging optical system, and wherein: the drive unit drives the second optical system based on information of the focusing distance and the position information stored in the storage unit.

An invention described in claim 7 is the lens barrel according to claim 5, wherein: the storage unit stores the position information of the second optical system according to an attitude at the time of image capturing, and wherein: the drive unit drives the second optical system based on information of an attitude at the time of the image capturing and the position information stored in the storage unit.

An invention described in claim 8 is the lens barrel according to any one of claims 1 to 7, wherein: the second optical system is an eccentric lens.

An invention described in claim 9 is the lens barrel according to any one of claims 1 to 8, wherein: the second optical system is a vibration reduction lens that corrects blur of an image.

An invention described in claim 10 is the lens barrel according to claim 9, wherein: the drive unit imparts drive power to the vibration reduction lens for drawing back thereof to a position at which aberration amount of the imaging optical system is suppressed, while the vibration reduction lens corrects blur of the image.

An invention described in claim 11 is the lens barrel according to any one of claims 1 to 8, comprising: a vibration reduction lens that is provided independently from the second optical system and corrects blur of an image.

An invention described in claim 12 is the lens barrel according to any one of claims 9 to 11, comprising: a blur detection unit that detects blur of an apparatus, wherein: the drive unit drives the vibration reduction lens so as to correct the blur according to an output of the blur detection unit.

An invention described in claim 13 is the lens barrel according to claim 12, wherein: the drive unit corrects blur of the image by driving the vibration reduction lens in a direction that intersects with an optical axis of the imaging optical system, according to an output of the blur detection unit.

An invention described in claim 14 is the lens barrel according to claim 12, wherein: the drive unit corrects blur of the image by driving the vibration reduction lens so as to be inclined relative to the first optical system, according to an output of the blur detection unit.

An invention described in claim 15 is the lens barrel according to any one of claims 1 to 14, wherein: the drive unit drives the second optical system before an image is captured by the imaging optical system, and does not drive the second optical system while the image is captured.

An invention described in claim 16 is a lens barrel comprising: an imaging optical system having a second optical system that can be moved relative to a first optical system; a storage unit that can store position information of the second optical system that corresponds to a focusing distance of the imaging optical system and in which an aberration amount of the imaging optical system is suppressed; and a drive unit that drives the second optical system based on information of the focusing distance and the position information stored in the storage unit.

An invention described in claim 17 is a lens barrel comprising: an imaging optical system having a second optical system that can be moved relative to a first optical system; a storage unit that can store position information of the second optical system that corresponds to an attitude at the time of image capturing and in which an aberration amount of the imaging optical system is suppressed; and a drive unit that drives the second optical system based on information of an attitude at the time of image capturing and the position information stored in the storage unit.

An invention described in claim 18 is the lens barrel according to claim 17, wherein: the storage unit can store position information of the second optical system that corresponds to an attitude around an optical axis of the imaging optical system at the time of capturing and in which an aberration amount of the imaging optical system is suppressed.

An invention described in claim 19 is the lens barrel according to any one of claims 16 to 18, wherein: the drive unit drives the second optical system so as to be inclined relative to the first optical system.

An invention described in claim 20 is a lens barrel comprising: an imaging optical system having a second optical system that can be moved relative to a first optical system; and a drive unit that drives the second optical system so as to be inclined relative to the first optical system so that aberration of the imaging optical system is reduced according to a position of the first optical system.

An invention described in claim 21 is the lens barrel according to claim 20, comprising: a storage unit that stores a relative inclination amount of the second optical system with respect to the first optical system, according to a position of the first optical system.

An invention described in claim 22 is a lens barrel comprising: an imaging optical system having a second optical system that can be moved relative to a first optical system; and a drive unit that drives the second optical system in a direction that intersects with an optical axis of the imaging optical system so that aberration of the imaging optical system is reduced according to a position of the first optical system.

An invention described in claim 23 is the lens barrel according to claim 22, comprising: a storage unit that stores a drive amount of the second optical system in a direction that intersects with the optical axis of the imaging optical system, according to a position of the first optical system.

An invention described in claim 24 is a lens barrel comprising: an imaging optical system having a second optical system that can be moved relative to a first optical system; and a drive unit that causes the second optical system to be driven relative to the first optical system so that aberration of the imaging optical system is reduced, after detecting an imaging condition and before capturing an image by way of the imaging optical system.

An invention described in claim 25 is the lens barrel according to claim 24, wherein: the drive unit causes the second optical system to be driven relative to the first optical system, after detecting a focusing distance of the imaging optical system and before capturing an image by way of the imaging optical system.

An invention described in claim 26 is the lens barrel according to claim 24, wherein: the drive unit causes the second optical system to be driven relative to the first optical system, after detecting an attitude at the time of image capturing and before capturing an image by way of the imaging optical system.

An invention described in claim 27 is an imaging apparatus comprising: a lens barrel according to any one of claims 1 to 26; and an imaging unit that captures an image by way of the imaging optical system.

An invention described in claim 28 is a method of adjusting a lens barrel, comprising steps of: driving a second optical system that can be moved relative to a first optical system, while measuring an aberration amount of an imaging optical system including the second optical system; and storing a position of the second optical system when the aberration amount of the imaging optical system is suppressed.

An invention described in claim 29 is the method of adjusting the lens barrel according to claim 28, comprising: a step of driving the second optical system in a direction that intersects with an optical axis of the imaging optical system.

An invention described in claim 30 is the method of adjusting the lens barrel according to claim 28, comprising: a step of driving the second optical system so that the second optical system is made to be inclined relative to the first optical system.

An invention described in claim 31 is the method of adjusting the lens barrel according to claim 28 or 30, comprising: a step of storing a position of the second optical system according to a focusing distance of the imaging optical system.

An invention described in claim 32 is the method of adjusting the lens barrel according to claim 28 or 30, comprising: a step of storing a position of the second optical system according to an attitude of the lens barrel.

An invention described in claim 33 is the method of adjusting the lens barrel according to any one of claims 28 to 32, comprising: a step of driving the second optical system to the position thus stored, before image capturing.

An invention described in claim 34 is a method of manufacturing a lens barrel, comprising steps of:

disposing a second optical system included in an imaging optical system so as to move relative to a first optical system included in the imaging optical system; and adjusting a drive unit that causes the second optical system to be driven relative to the first optical system so that aberration of the imaging optical system can be reduced according to an imaging condition.

An invention described in claim 35 is the method of manufacturing the lens barrel according to claim 34, comprising: a step of storing position information of the second optical system in which aberration of the imaging optical system is reduced, according to a focus distance of the imaging optical system.

An invention described in claim 36 is the method of manufacturing the lens barrel according to claim 34, comprising: a step of storing position information of the second optical system in which aberration of the imaging optical system is reduced, according to an attitude of the lens barrel.

### EFFECTS OF THE INVENTION

According to the present invention, it is possible to provide a lens barrel, a method of adjusting a lens barrel, a manufacturing method of a lens barrel, and an imaging device that can realize a preferred imaging.

### BRIEF DESCRIPTION OF THE DRAWINGS

FIG. 1 is a system configuration diagram of a lens barrel and an alignment tool for performing alignment of the lens barrel according to a first embodiment;

FIG. 2 shows a flow during alignment according to the first embodiment;

FIG. 3 is a diagram showing an example of a best aberration position at a T end, an M position, and a W end;

FIG. 4 is a diagram showing an operational flow of aberration correction when the vibration correction SW is in an ON state;

FIG. 5 is a diagram showing an operational flow of aberration correction when the vibration correction SW in an OFF state;

FIG. 6 is a system configuration diagram of a lens barrel and an alignment tool for performing alignment of the lens barrel according to a second embodiment;

FIG. 7 shows a flow during alignment according to the second embodiment;

FIG. 8 is a diagram showing an example of a best aberration position at +90 degrees, +180 degrees, and +270 degrees;

FIG. 9 is a diagram showing an operational flow of aberration correction when the vibration correction SW is in an ON state;

FIG. 10 is a diagram showing an operational flow of aberration correction when the vibration correction SW is in an OFF state;

FIG. 11 is a system configuration diagram of a lens barrel and an alignment tool for performing alignment of the lens barrel according to a third embodiment;

FIG. 12 shows a flow during an alignment operation according to the third embodiment;

FIG. 13 is a diagram showing an example of a best aberration position at a T end, an M position, and a W end;

FIG. 14 is a diagram showing an operational flow of aberration correction when the vibration correction SW is in an ON state;

FIG. 15 is a diagram showing an operational flow of aberration correction when the vibration correction SW is in an OFF state;

FIG. 16 is a system configuration diagram of a lens barrel and an alignment tool according to a fourth embodiment;

FIG. 17 is a flowchart showing an operating procedure during alignment according to the fourth embodiment;

FIG. 18 is a diagram illustrating the relationship between a focusing distance from the W end to the T end and an alignment position that is the best aberration position;

FIG. 19 is a schematic configuration of a camera to which a lens barrel according to the fourth embodiment is mounted;

FIG. 20 is a flowchart showing an operating procedure of aberration correction when the vibration correction SW is in an ON state according to the fourth embodiment;

FIG. 21 is a flowchart showing an operating procedure of aberration correction when the vibration correction SW is in an OFF state according to the fourth embodiment;

FIG. 22 shows a configuration of a case in which aberration is corrected by a lens that is disposed at a subsequent stage to the vibration reduction lens in a fifth embodiment;

FIG. 23 shows a configuration of a case in which aberration is corrected by a lens that is disposed at a subsequent stage to the vibration reduction lens in a sixth embodiment;

FIG. 24 shows a configuration of a case in which vibration reduction is performed by driving the vibration correction lens to be tilted and aberration correction is performed by driving it to be shifted in a seventh embodiment;

FIG. 25 shows a configuration of a case in which aberration is corrected by a lens that is disposed at a subsequent stage to the vibration reduction lens in an eighth embodiment;

FIG. 26 shows a configuration of a case in which vibration reduction and aberration correction is performed by driving the vibration correction lens to be tilted in a ninth embodiment; and

FIG. 27 shows a configuration of a case in which vibration reduction and aberration correction is performed by driving the vibration correction lens to be tilted in a tenth embodiment.

### PREFERRED MODE FOR CARRYING OUT THE INVENTION

In the following, embodiments of an optical device, a method for adjusting an optical device, a manufacturing method of an optical device, a lens barrel, a method for adjusting a lens barrel, and an imaging device according to the present invention are described with reference to the drawings. In each embodiment shown below, although a lens barrel that is detachable with respect to a camera is exemplified as an optical device, the present invention is not limited thereto and may be another optical device such as a fixed-lens still camera or a video camera. In addition, each embodiment shown below is simply shown for facilitating understanding of the present invention and is not intended to exclude carrying out addition, substitution, and the like that can be implemented by those skilled in the art within a scope not departing from the technical concept of the present invention.

### First Embodiment

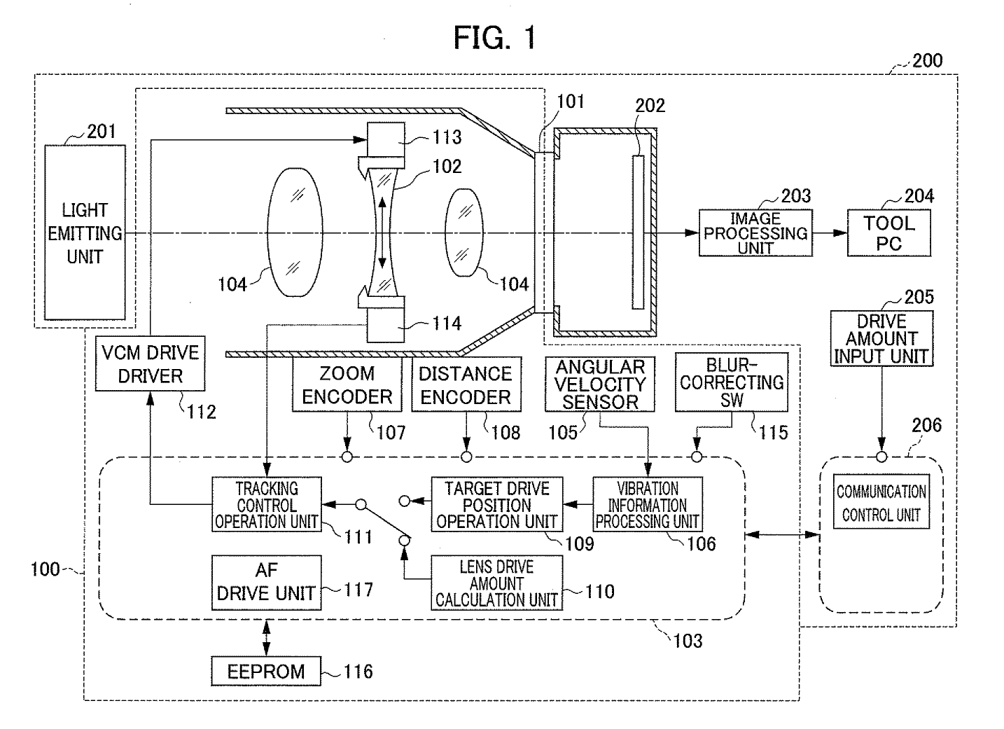

FIG. 1 is a system configuration diagram of a lens barrel 100 and an alignment tool 200 for performing alignment of the lens barrel 100 according to a first embodiment. The alignment tool 200 includes a light emitting unit 201 that emits collimated light from a leading end side of the lens barrel 100 and an image pickup device 202 that is mounted to a mounting unit 101 of the lens barrel 100, receives light emitted from the light emitting unit 201 and passing through the lens barrel 100, and converts the light to an electric signal by way of photoelectric conversion. Furthermore, the alignment tool 200 includes an image processing unit 203 that converts the electric signal obtained from the image pickup device 202 to graphic information, and a tool PC 204 that converts to an aberration amount based on the graphic information obtained by the image processing unit 203 to display on a screen.

Furthermore, the alignment tool 200 includes a drive amount input unit 205 such as a joystick that allows an operator to operate by viewing the aberration value displayed on the monitor of the tool PC 204. According to a signal inputted from this drive amount input unit 205, a vibration reduction lens 102 is driven in the lens barrel 100 as described later.

The alignment tool 200 further includes a tool CPU 206 that communicates imaging surface moving distance information of the vibration reduction lens 102 to the lens CPU 103 based on the signal of the drive amount input unit 205. This communication is performed via the mounting unit 101 of the lens barrel 100. In addition, the tool CPU 206 supplies electric power in order to drive the lens CPU 103 and the vibration reduction lens 102. Furthermore, the tool CPU 206 loads from the lens CPU 103 information of a zoom encoder 107 in the lens barrel 100 and extension amount information of a lens unit 104 (information of a distance encoder 108) in a case of focusing. The zoom encoder 107 detects a zooming state (a focusing distance) of the lens unit 104.

On the other hand, the lens barrel 100, as an imaging optical system, includes the vibration reduction lens 102 that corrects blur of an image and the lens unit 104 that moves while zooming, and, as described above, further includes the lens CPU 103 that communicates with the tool CPU 206. The lens CPU 103 includes therein a program for an alignment mode to perform alignment. When the lens barrel 100 is mounted to the alignment tool 200, the lens CPU 103 identifies the connection by communication with the tool CPU 206 and transitions to the alignment mode. With the transition to the alignment mode, it becomes possible to drive and control the vibration reduction lens 102 based on the imaging surface moving information of the vibration reduction lens 102 that is transmitted from the tool CPU 206.

The lens barrel 100 further includes an angular velocity sensor 105 that detects an angular velocity. An output of an angular velocity detected by the angular velocity sensor 105 passes through an LPF+amplifier unit so that an unwanted high-frequency noise is removed, and is inputted to a vibration information processing unit 106. The angular velocity sensor 105 does not function in the alignment mode. The vibration information processing unit 106 extracts vibration information to be reduced based on information of the angular velocity sensor 105.

Furthermore, the lens barrel 100 includes the zoom encoder 107, the distance encoder 108, and a target drive position operation unit 109 that performs calculation of a target drive position of the vibration reduction lens 102 based on these outputs of the vibration information processing unit 106.

The lens barrel 100 includes a lens drive amount calculation unit 110, and the lens drive amount calculation unit 110 functions during the transition to the alignment mode. In the lens drive amount calculation unit 110, the imaging surface moving information of the vibration reduction lens 102 that is transmitted from the tool CPU 206 is converted to moving distance information of the vibration reduction lens 102 based on anti-vibration correction (vibration compensation) coefficient information that is stored in EEPROM 116. Herein, the anti-vibration correction coefficient information is information of a ratio between a moving distance of the vibration reduction lens 102 and a moving distance of an image caused by the movement of the vibration reduction lens 102, and is retained as matrix information in which the inputs to the zoom encoder 107 and the distance encoder 108 are used as parameters. Furthermore, an alignment adjustment value that is transmitted from the tool CPU 206 is converted to lens position information in this lens drive amount calculation unit 110, and stored in the EEPROM 116.

The lens barrel 100 includes a tracking control operation unit 111 that, based on the information from the target drive position operation unit or the lens drive amount calculation unit 110, performs a tracking control operation of the vibration reduction lens 102 and a VCM drive driver 112 that supplies electric power to a VCM 113 (voice coil motor) according to a signal from the tracking control operation unit 111. The VCM 113 is an electromagnetic-drive actuator and is composed of a coil and a magnet to generate drive power by flowing electric current to the coil. This VCM 113 allows the vibration reduction lens 102 to be driven within a level plane that is perpendicular to the optical axis. The drive unit is not limited to the VCM 113 and may be a PZT (lead zirconate titanate) type actuator such as SIDM (Smooth Impact Drive Mechanism, micro actuator) or S™ (stepping motor).

The lens barrel 100 includes a position detection unit 114 that detects a position of the vibration reduction lens 102. The method of using a PSD (Position Sensitive Detector) is common for position detection. The position of the vibration reduction lens 102 obtained by the position detection unit 114 is fed back to the tracking control operation unit 111. The position detection unit 114 is not limited to the abovementioned PSD and may be a position detection unit 114 that detects a fluctuation of magnetic flux density using a magnet and a Hall element.

The lens barrel 100 includes a vibration reduction SW 115, which is a switch by which a user can select an ON/OFF state of a vibration reduction. In an ON state of the vibration reduction, the vibration reduction lens 102 moves within the plane that is perpendicular to the optical axis so as to negate the blur, according to an output of the angular velocity sensor 105. When the vibration reduction is in an OFF state, the optical axis and the vibration reduction lens 102 are fixed by a locking mechanism (not illustrated) at a position where centers thereof coincide with each other. Furthermore, the lens barrel 100 includes an AF drive unit 117 that performs focusing.

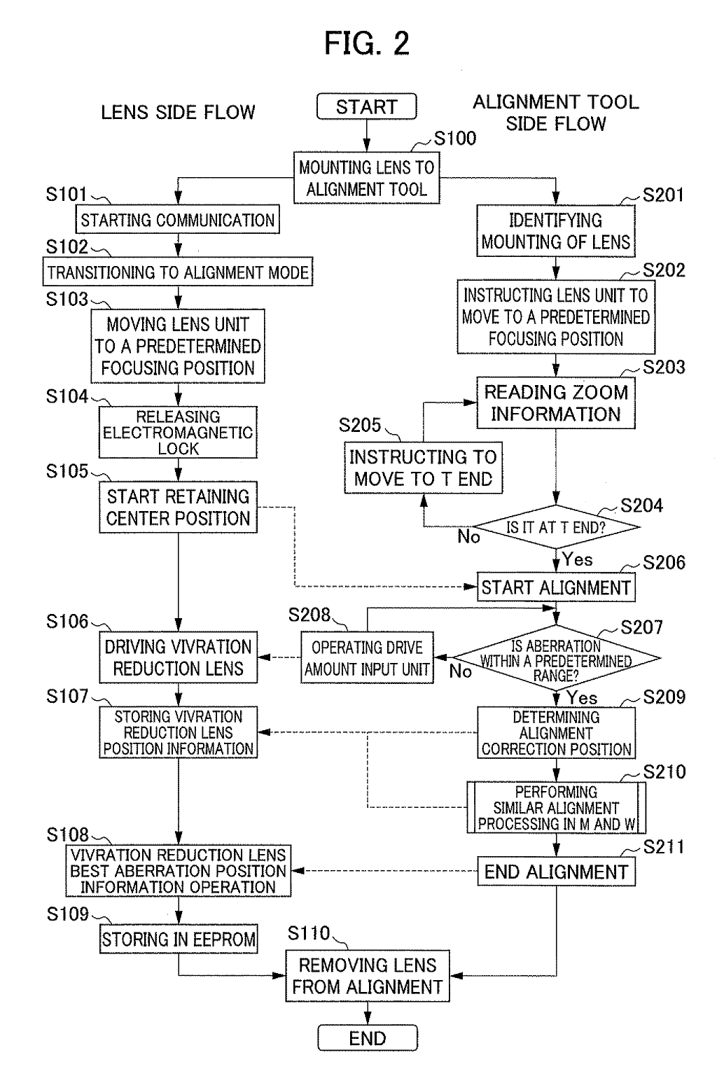

Next, an operation during alignment is described. FIG. 2 shows a flow during alignment. First, the lens barrel 100 is mounted to the alignment tool 200 (S100). Then, the alignment tool 200 identifies mounting of the lens barrel 100 (S201) and supplies electric power to the lens barrel 100 side.

On the other hand, with the lens barrel 100, the lens CPU 103 starts communication with the tool CPU 206 (S101). The lens CPU 103 includes a program for an alignment mode for alignment as described above and, when the lens CPU 103 detects that it is mounted to the alignment tool 200, it transitions to the alignment mode (S102).

The alignment tool 200 instructs the AF drive unit 117 in the lens barrel 100 to drive the lens unit 104 to a predetermined focusing position (S202). The lens unit 104 is moved to a predetermined position according to the instruction thereof (5103). A predetermined position of this focusing is a predetermined start position such as an infinity position.

The lens barrel 100 releases an electromagnetic lock (not illustrated) before driving the vibration reduction lens 102 (S104). The electromagnetic lock is a locking mechanism for fixing the vibration reduction lens 102 to a predetermined position. By releasing this electromagnetic lock, it becomes possible to drive the vibration reduction lens 102 by the drive power of the VCM 113.

The alignment tool 200 reads zoom information identified by the lens CPU 103 (S203) and determines whether the lens barrel is on a T end (S204). The reading of this zoom information is performed by the tool CPU 206 receiving a value of the zoom encoder 107 of the lens barrel 100 by way of the communication from a contact of the mounting unit 101 on a lens side. When the lens barrel 100 is not at the T (tele) end (No in S204), for example, an operator is instructed to move the lens barrel 100 to the T (tele) end through the monitor of the tool PC 204 (S205).

The lens barrel 100 starts tracking control by setting a center position that the EEPROM 116 includes to a target drive position of the vibration reduction lens 102. When moving to the center position (105), a signal indicating that the alignment operation can be started is transmitted to the CPU side of the alignment tool 200.

The alignment tool 200 starts alignment when receiving the signal indicating that alignment can be started from the lens barrel 100 (S206). The alignment is performed at least at two positions depending on a focusing distance of the lens barrel 100. In the present embodiment, the alignment is performed at three positions, which are a T (tele) end, a W (wide) end, and an M (middle) position therebetween.

The alignment tool 200 observes an extent of aberration from on an image of light that is emitted from the light emitting unit 201 via the monitor of the tool PC 204, passes through the lens barrel 100, and entering the image pickup device 202, and determines whether the aberration is within a predetermined range (S207). In a case in which the aberration is not within a predetermined range (No in S207), the drive amount input unit 205 is operated by an operator (S208), and the vibration reduction lens is driven to a best aberration position at which aberration is minimized. The drive amount input unit 205 outputs a drive amount (□XI, □YI) of the vibration reduction lens 102 thus driven to the lens barrel 100 side.

The drive amount information (ΔXI, ΔYI) transmitted from the tool CPU 206 is converted to a position of the vibration reduction lens 102 (ΔXI/VR1, ΔYI/VR1), and the vibration reduction lens 102 is driven to modify a target drive position (S106). The target drive position of the vibration reduction lens 102 is a position (XLC+ΔXI/VR1, YLC+ΔYI/VR1) which is equal to the present target drive position of the vibration reduction lens 102 (XLC, YLC) added by the above-mentioned converted values (ΔXI/VR1, ΔYI/VR1). Herein, VR1 indicates an anti-vibration correction (vibration compensation) coefficient at a predetermined focusing distance and is used by reading a numeral value stored in the EEPROM 116.

In a case in which the aberration is within the predetermined range (Yes in S207), a signal of an alignment correction position determination is transmitted to the lens CPU 103 side (S209). After receiving the signal of the alignment correction position determination, the lens CPU 103 side stores in RAM the target position information of the vibration reduction lens 102 (XLC, YLC) as the best aberration position information at the T end (XLC1, YLC1) (S107).

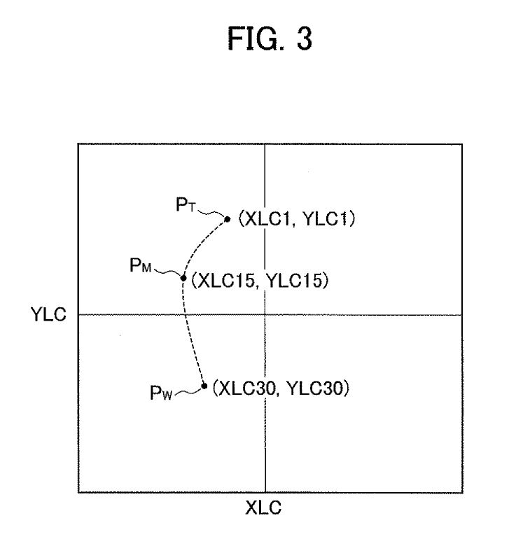

When adjustment at the T end ends, a similar adjustment is performed at the M position and the W end (S210). The lens CPU 103 stores in the RAM the best aberration position information at each of the positions (S107). FIG. 3 is a diagram illustrating an example of a best aberration position at the T end, the M position, and the W end. In the drawings, suffixes 1, 15, and 30 indicate positions of the zoom encoder 107. In a case in which the T end side is 1 and a division number of the zoom encoder 107 is 30, the W end side becomes 30 and the M position becomes 15. The best aberration position at the T end (the center position of the vibration reduction lens 102 in a case in which the aberration is minimized (XLC, YLC)) is the position of P_{T} in the drawings (XLC1, YLC1). The best aberration position at M is the position of P_{M} in the drawings (XLC15, YLC15). The best aberration position at the W end is the position of P_{W} in the drawings (XLC30, YLC30).

After ending the alignment (211), an end notification is transmitted to the lens CPU 103. On the lens CPU 103 side, based on the best aberration position information of the focusing distance of the three positions, best aberration position information at another zoom position is computed and interpolated so as to calculate best aberration position information according to each of the zoom positions (S108).

After completion of interpolation processing according to a zoom position of the best aberration position information of the vibration reduction lens 102, the data thereof is stored in the EEPROM 116 as the best aberration position information of the vibration reduction lens 102 at all of the zoom positions (S109). Then, the lens barrel 100 is removed from the alignment tool 200 (S110), thereby ending the alignment process.

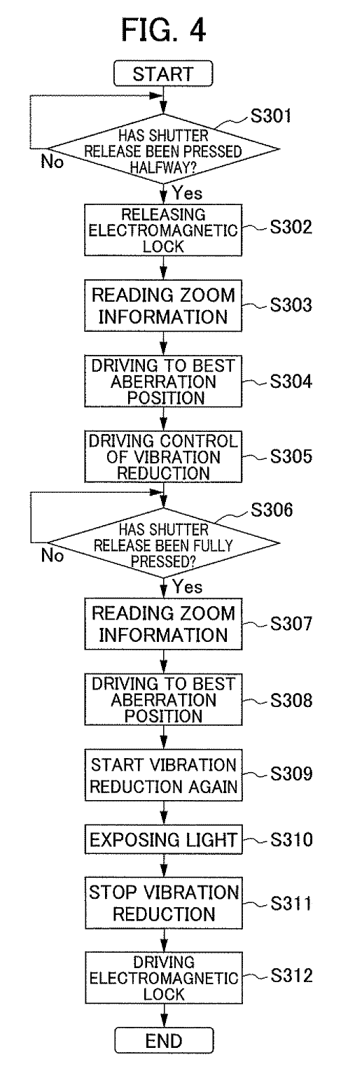

Next, operation of aberration correction, when the vibration reduction SW 115 is in an ON state, using the best aberration position information of the vibration reduction lens 102 that is calculated in the alignment process is described. FIG. 4 is a diagram showing an operational flow of aberration correction when the vibration correction SW 115 is in an ON state.

When the shutter release of a camera is half pressed in a state in which the lens barrel 100 is mounted to the camera (not illustrated) (S301), supply of electric power to the vibration reduction lens 102 is started and a vibration reduction sequence is started.

First, an electromagnetic lock that mechanically regulates the movement of the vibration reduction lens 102 is released (S302).

The zoom information of the current lens barrel 100 is read by the lens CPU 103 (S303). The vibration reduction lens 102 is temporarily driven to the best aberration position (XLC, YLC) at the zoom position of the current lens barrel 100 (S304). This best aberration position differs depending on a value of the zoom encoder 107: as described above, the position of P_{T} (XLC1, YLC1) in FIG. 3 at the time of the T end; the position of P_{M} (XLC15, YLC15) at the time of the M position; the position of P_{w} (XLC30, YLC30) at the time of the W end. Furthermore, the best aberration positions at the intermediate positions thereof are the positions computed and interpolated in S108 of FIG. 2.

Based on the output of the angular velocity sensor 105, drive control of the vibration reduction lens 102 is started so as to steady an image on the imaging surface (S305). When shutter release of the camera is pressed fully (Yes in 306), zoom information is read again similarly to the above-mentioned S303 while a quick return mirror (not illustrated) is springing up.

Furthermore, similarly to the abovementioned S304, the vibration reduction lens 102 is driven to the best aberration position (XLC, YLC) at the zoom position of the lens barrel 100 at the time of the shutter release being fully pressed (S308). Then, after driving to the best aberration position, the vibration reduction is started again (S309).

Vibration reduction is performed, light is exposed at a predetermined shutter speed (S310), and the vibration reduction is stopped (S311). Afterwards, the electromagnetic lock is driven (S312) and the operational flow ends. In a case of a half press timer being activated, drive for vibration reduction is performed; however, in a case of the half press timer being deactivated, the electromagnetic lock is driven and the vibration reduction lens 102 is retained mechanically.

Thus, since the vibration reduction is started around the best aberration position obtained in the alignment process so as to perform imaging, it becomes possible to perform imaging at the best position for aberration performance in consideration of optical performance.

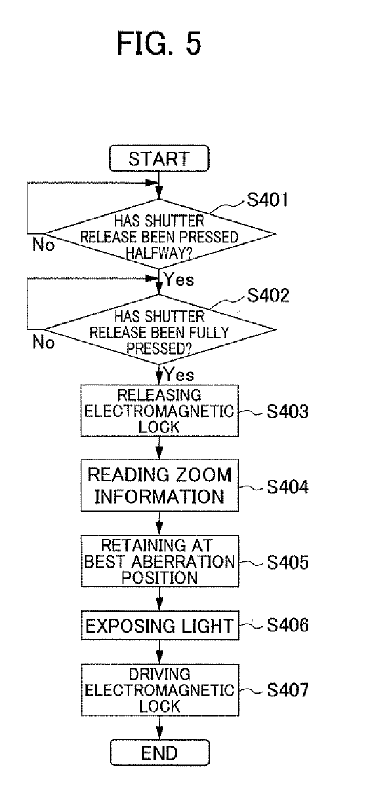

With reference to FIG. 5, an operation of aberration correction in a case of the vibration reduction SW 115 being in an OFF state, using the best aberration position information of the vibration reduction lens 102 that is calculated in the alignment process is described. FIG. 5 is a diagram showing an operational flow of aberration correction when the vibration correction SW is in an OFF state.

When the shutter release of the camera is half pressed (S401) and then fully pressed (S402) in a state in which the lens barrel 100 is mounted to the camera (not illustrated), a quick return mirror (not illustrated) springs up and the electromagnetic lock is released (S403).

Then, the zoom information of the current lens barrel 100 is read by the lens CPU 103 (S404). Then, the vibration reduction lens 102 is driven to the best aberration position (XLC, YLC) at the zoom position of the current lens barrel 100 (S405). Similarly to the abovementioned case of the vibration reduction SW115 being in the ON state, this best aberration position differs depending on a value of the zoom encoder 107, as described above, the position of P_{T} in FIG. 3 at the time of the T end; the position of P_{M} at the time of the M position; the position of P_{W} at the time of the W end. Furthermore, the center positions at the intermediate positions thereof are the positions that is computed and interpolated in S108 of FIG. 2. Then, light is exposed at a predetermined shutter speed (S406), then the electromagnetic lock is driven (S407), and the operational flow ends.

Thus, even when the vibration reduction SW 115 is in an OFF state, since imaging is performed at the best aberration position obtained in the alignment process, it becomes possible to perform imaging at the best position for aberration performance in consideration of optical performance.

From the above, the first embodiment has the following effects.

(1) The position of the vibration reduction lens 102 at which an aberration generated on the imaging surface by the imaging optical system composed of a plurality of the lens units 104 included in the lens barrel 100 is minimized is stored in the lens CPU 103 as a best aberration position that corresponds to a focusing distance for each individual lens barrel 100. At the time of imaging, imaging is performed after the vibration reduction lens 102 is moved to the best aberration position at the focusing distance. In this way, since the aberrations that differ depending on the lens barrels 100 are adjusted for each of the lens barrels 100, the aberration of each of the lens barrels can be minimized.

In the present embodiment, for example, the vibration reduction lens 102 is moved to the best aberration position after the focusing distance is detected by the zoom encoder 107 and before photoelectric conversion is performed by the image pickup device 202. Therefore, aberration of the image that has been captured by the image pickup device 202 can be suppressed. Although the present embodiment is described using the best aberration position, it is not limited thereto. For example, it may be anything that can reduce a small aberration by moving the vibration reduction lens 102.

(2) Furthermore, since the best aberration position fluctuates so that aberration is minimized according to the focusing distances, it becomes possible to perform imaging at the best position for aberration performance in consideration of optical performance at each of the focusing distances.

(3) Since an existing vibration reduction lens 102 is used, it is not necessary to add new components for aberration correction.

(4) Since vibration reduction is performed around the best aberration position, it is possible to perform quick vibration correction.

### Modified Embodiment

Without being limited to the first embodiment described above, various changes and modifications as shown below are possible thereto, and these are also within the scope of the present invention.

(1) In the abovementioned first embodiment, although the configuration is exemplified in which correction of aberration is performed using the vibration reduction lens, the present invention is not limited thereto. Without being limited to the vibration reduction lens, for example, another lens can be used so long as it is a lens that can move to a surface perpendicular to the optical axis, and, for example, it may be a configuration in which a lens for aberration correction is additionally provided.

For example, in a case in which the lens that corrects aberration is a vibration reduction lens, the vibration reduction lens may be drawn back (centering) to a position at which aberration stored in a storage unit is made small. This is because it is possible to perform imaging in a better state of optical characteristic by drawing back the vibration reduction lens to a position in which aberration is made small. Furthermore, by drawing back the vibration reduction lens to a position at which aberration is made small, a drive range in which the vibration reduction lens can drive can be made substantially large.

Drawing back of the vibration reduction lens may be performed before imaging by the imaging unit (before exposing light) and may be performed during imaging by the imaging unit (while exposing light). Furthermore, the vibration reduction lens is not limited to one that is perpendicular to the optical axis.

For example, in a case in which aberration is corrected using a lens other than the vibration reduction lens, it is preferable to correct aberration by driving a lens that corrects aberration before exposing light and to stop the lens that corrects aberration while exposing light. Since the lens that corrects aberration while exposing light is stopped, it is possible to suppress unwanted image blur.

(2) Although the abovementioned first embodiment is configured in a structure in which the alignment tool is mounted to the lens barrel, the present invention is not limited thereto.

For example, it may be a structure in which a camera includes a function of the alignment tool. In this case, an image pickup device of the alignment tool can be used as an image pickup device of a camera.

(3) Although the abovementioned first embodiment is described so that an operator operates the drive amount input unit so as to drive the vibration reduction lens to the best aberration position at which aberration is minimized, the present invention is not limited thereto. For example, it may be configured so that the tool CPU drives the vibration reduction lens to the best aberration position automatically.

(4) In the abovementioned first embodiment, although measurement of alignment is performed at the T end, the M position, and the W end, the present invention is not limited thereto. It is possible to correct aberration with higher accuracy by performing measurement at least at three positions.

The abovementioned first embodiment and the modified embodiment can be combined appropriately to be used; however, a detailed explanation thereof is omitted. In addition, the present invention is not limited to the embodiments described above.

### Second Embodiment

Next, a second embodiment is described. In the second embodiment, portions equivalent to the first embodiment are assigned the same reference numerals and described.

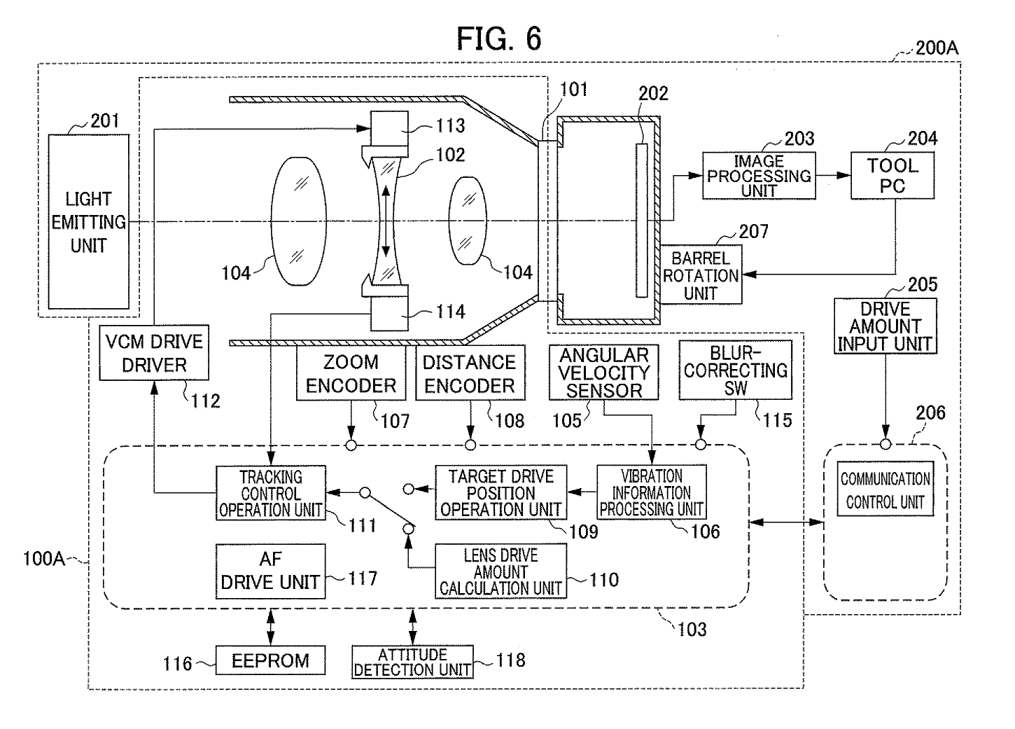

FIG. 6 is a system configuration diagram of a lens barrel 100A and an alignment tool 200A for performing alignment of the lens barrel 100A according to the second embodiment. The alignment tool 200A includes a light emitting unit 201 that emits collimated light from a leading end side of the lens barrel 100A and an image pickup device 202 that is mounted to a mounting unit 101 of the lens barrel 100A, receives light emitted from the light emitting unit 201 and passing through the lens barrel 100A, and converts the light to an electric signal by way of photoelectric conversion. Furthermore, the alignment tool 200A includes an image processing unit 203 that converts the electric signal obtained from the image pickup device 202 to graphic information and a tool PC 204 that converts to an aberration amount based on the graphic information obtained by the image processing unit 203 to display on a screen.

In addition, the alignment tool 200A includes a barrel rotation unit 207 that causes the entire lens barrel 100A to rotate about the optical axis according to the instruction from the tool PC 204. The alignment tool 200A further includes a drive amount input unit 205 such as a joystick that allows an operator to input an aberration value by viewing the aberration value displayed on the monitor of the tool PC 204. According to a signal inputted from this drive amount input unit 205, a vibration reduction lens 102 is driven in the lens barrel 100A as described later.

The alignment tool 200A further includes a tool CPU 206 that communicates imaging surface moving distance information of the vibration reduction lens 102 to the lens CPU 103 based on the signal of the drive amount input unit 205. This communication is performed via the mounting unit 101 of the lens barrel 100A. In addition, the tool CPU 206 supplies electric power in order to drive the lens CPU 103 and the vibration reduction lens 102. Furthermore, the tool CPU 206 loads from the lens CPU 103 information of a zoom encoder 107 in the lens barrel 100A and extension amount information of a lens unit 104 (information of a distance encoder 108) and information of an attitude detection unit 118 in a case of focusing, as described later.

On the other hand, the lens barrel 100A, as an imaging optical system, includes the vibration reduction lens 102 that corrects blur of an image, and the lens unit 104 that moves while zooming, and, as described above, further includes the lens CPU 103 that communicates with the tool CPU 206. The lens CPU 103 includes therein a program for an alignment mode to perform alignment.

When the lens barrel 100A is mounted to the alignment tool 200A, the lens CPU 103 identifies a connection state by communication with the tool CPU 206, and transitions to the alignment mode. With the transition to the alignment mode, it becomes possible to drive and control the vibration reduction lens 102 based on the imaging surface moving information of the vibration reduction lens 102 that is transmitted from the tool CPU 206.

The lens barrel 100A further includes an angular velocity sensor 105 that detects an angular velocity. An output of an angular velocity detected by the angular velocity sensor 105 passes through an LPF+amplifier unit (not illustrated) so that an unwanted high-frequency noise is removed, and is inputted to a vibration information processing unit 106. The angular velocity sensor 105 does not function in the alignment mode. The vibration information processing unit 106 extracts blur information to be corrected based on information of the angular velocity sensor 105. Furthermore, the lens barrel 100A includes the attitude detection unit 118 composed of a triaxial acceleration sensor for detecting an attitude of the lens barrel 100A. This attitude detection sensor 118 detects an angle about the optical axis of the lens barrel 100A based on an output of the triaxial acceleration sensor.

Furthermore, the lens barrel 100A includes the zoom encoder 107, the distance encoder 108, and a target drive position operation unit 109 that performs calculation of a target drive position of the vibration reduction lens 102 based on these outputs of the vibration information processing unit 106.

The lens barrel 100A includes a lens drive amount calculation unit 110 that functions during the transition to the alignment mode. In the lens drive amount calculation unit 110, the imaging surface moving information of the vibration reduction lens 102 that is transmitted from the tool CPU 206 is converted to moving distance information of the vibration reduction lens 102 based on anti-vibration correction coefficient information that is stored in EEPROM 116. Herein, the anti-vibration correction coefficient information is information of a ratio between a moving distance of the vibration reduction lens 102 and a moving distance of an image according to the movement of the vibration reduction lens 102, and is retained as matrix information in which the inputs to the zoom encoder 107 and the distance encoder 108 are used as parameters. Furthermore, an alignment adjustment value that is transmitted from the tool CPU 206 is converted to lens position information at this lens drive amount calculation unit 110, and is stored in the EEPROM 116.

The lens barrel 100A includes a tracking control operation unit 111 that performs a tracking control operation of the vibration reduction lens 102 based on the information from the target drive position operation unit or the lens drive amount calculation unit 110 and a VCM drive driver 112 that supplies electric power to a VCM 113 (voice coil motor) according to a signal from the tracking control operation unit 111. The VCM 113 is an electromagnetic-drive actuator and is composed of a coil and a magnet to generate drive power by flowing electric current to the coil. This VCM 113 allows the vibration reduction lens 102 to drive with a level plane that is perpendicular to the optical axis. The drive unit is not limited to the VCM 113 and may be a PZT (lead zirconate titanate) type actuator such as SIDM (Smooth Impact Drive Mechanism) or S™ (stepping motor).

The lens barrel 100A includes a position detection unit 114 that detect a position of the vibration reduction lens 102. The method of using a PSD (Position Sensitive Detector) is common for position detection. The position of the vibration reduction lens 102 obtained at the position detection unit 114 is fed back to the tracking control operation unit 111. The position detection unit 114 is not limited to the abovementioned PSD and may be a position detection unit 114 that detects a fluctuation of magnetic flux density using a magnet and a Hall element.

The lens barrel 100A includes a vibration reduction SW 115, which is a switch by which a user can select an ON/OFF state of a vibration reduction. In an ON state of the vibration reduction, the vibration reduction lens 102 moves within the level plane that is perpendicular to the optical axis so as to negate blur, according to an output of the angular velocity sensor 105. In an OFF state of the vibration reduction, the optical axis and the vibration reduction lens 102 are fixed by a locking mechanism (not illustrated) at a position where centers thereof coincide with each other. Furthermore, the lens barrel 100A includes an AF drive unit 117 that performs focusing.

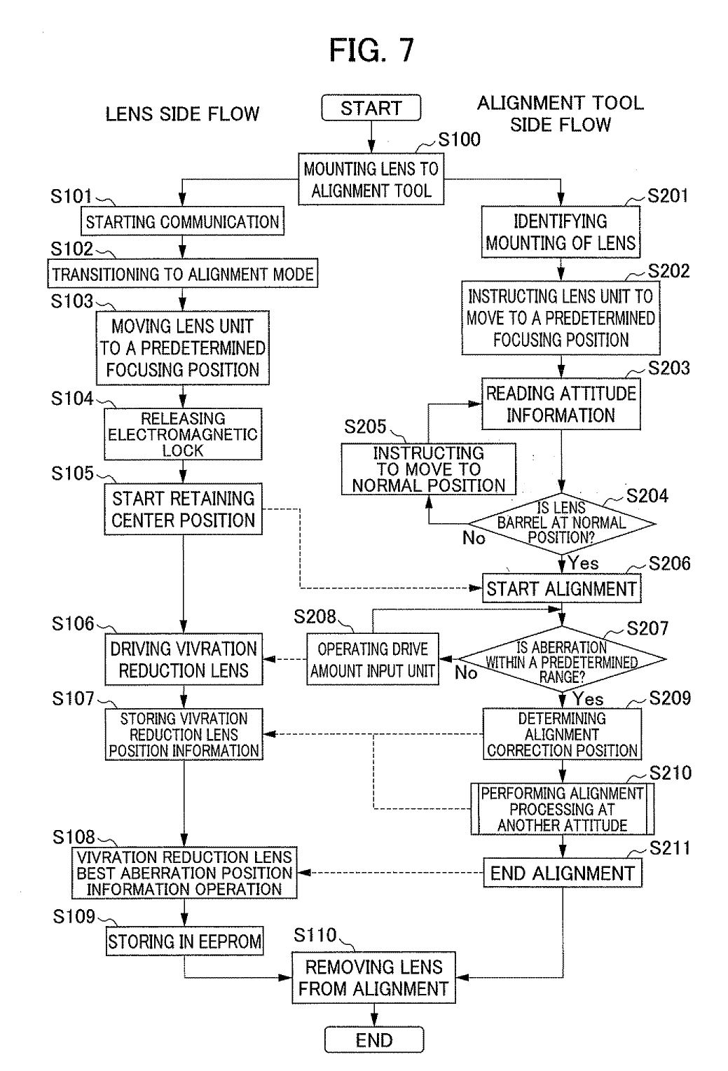

Next, an operation during alignment is described. FIG. 7 shows a flowchart during alignment. First, the lens barrel 100A is mounted to the alignment tool 200A (S100). Then, the alignment tool 200A identifies mounting of the lens barrel 100A (S201) and supplies electric power to the lens barrel 100A side.

On the other hand, the lens CPU 103 starts communication with the tool CPU 206 in the lens barrel 100A (S101). The lens CPU 103 includes a program for an alignment mode for alignment as described above and, when the lens CPU 103 detects that it is mounted to the alignment tool 200A, it transitions to the alignment mode (S102).

The alignment tool 200A instructs such that the lens unit 104 is driven to a predetermined focusing position by the AF drive unit 117 in the lens barrel 100A (S202). The lens unit 104 is moved to a predetermined position according to the instruction (S103).

This predetermined focusing position is a predetermined start position such as an infinity position.

The lens barrel 100A releases an electromagnetic lock (not illustrated) before driving the vibration reduction lens 102 (S104). The electromagnetic lock is a locking mechanism for fixing the vibration reduction lens 102 at a predetermined position. By releasing this electromagnetic lock, it becomes possible to drive the vibration reduction lens 102 by the drive power of the VCM 113.

The alignment tool 200A reads attitude information identified by the lens CPU 103 (S203) and determines whether the lens barrel is at a normal position (S204). The reading of this attitude information is performed by the tool CPU 206 receiving a value of the attitude detection unit 118 of the lens barrel 100A by way of communication from contact of the mounting unit 101 on a lens side. When the lens barrel 100A is not at the normal position (No in S204), for example, an operator is instructed to move the lens barrel 100A to the normal position through the monitor of the tool PC 204 (S205).

The lens barrel 100A starts tracking control by setting a center position that the EEPROM 116 includes to a target drive position of the vibration reduction lens 102. When moving to the center position (105), a signal indicating that alignment operation can be started is transmitted to the alignment tool 200A side.

The alignment tool 200A starts alignment when receiving the signal indicating that alignment can be started from the lens barrel 100A (S206). The alignment is performed at least at three positions including a normal position and positions rotated by +90 degrees and −90 degrees around the optical axis, according to the attitude of the lens barrel 100A. In the present embodiment, the alignment is performed at four positions including a normal position and positions rotated by +90 degrees, +180 degrees, and +270 degrees (−90 degrees). In a case of a lens in which it is possible to perform imaging with the optical axis in a downward direction, the alignment is also performed in a state in which the optical axis is directed to a downward direction.

The alignment tool 200A observes, via the monitor of the tool PC 204, an extent of aberration based on an image of light that is emitted from the light emitting unit 201, passes through the lens barrel 100A, and entering the image pickup device 202 and determines whether the aberration is within a predetermined range (S207). In a case in which the aberration is not within a predetermined range (No in S207), the drive amount input unit 205 is operated by an operator (S208), and the vibration reduction lens is driven to a best aberration position at which aberration is minimized. The drive amount input unit 205 outputs a drive amount (ΔXI, ΔYI) of the vibration reduction lens 102 thus driven to the lens barrel 100A side.

The drive amount information (ΔXI, ΔYI) transmitted from the tool CPU 206 is converted to a position of the vibration reduction lens 102 (ΔXI/VR1, ΔYI/VR1), and the vibration reduction lens 102 is driven to modify a target drive position (S106). The target drive position of the vibration reduction lens 102 is a position (XLC+ΔXI/VR1, YLC+ΔYI/VR1) that is equal to the present target drive position of the vibration reduction lens 102 (XLC, YLC) added by the above-mentioned converted values (ΔXI/VR1, ΔYI/VR1). Herein, VR1 indicates an ant vibration correction coefficient at a predetermined focusing distance, and is used by reading a numeral value stored in the EEPROM 116.

In a case in which the aberration is within the predetermined range (Yes in S207), a signal of alignment correction position determination is transmitted to the lens CPU 103 side (S209).

After receiving the signal of the alignment correction position determination, the lens CPU 103 side stores in RAM the target position information of the vibration reduction lens 102 (XLC, YLC) as the best aberration position information at the normal position (XLC1, YLC1) (S107).

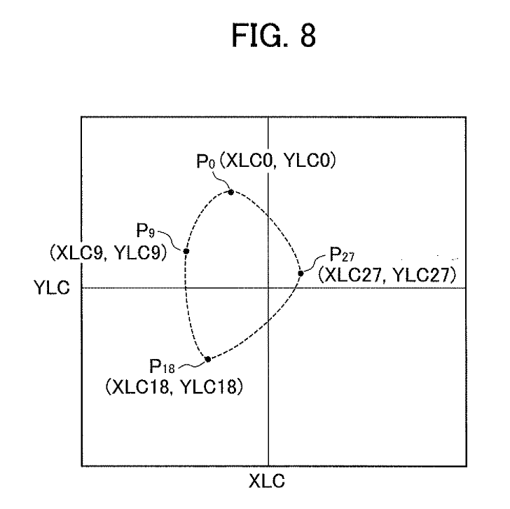

When an adjustment at the normal position ends, a similar adjustment is performed at +90 degrees, +180 degrees, and +270 degrees (S210). The lens CPU 103 stores to the RAM the best aberration position information at each of the attitudes (S107). FIG. 8 is a diagram illustrating an example of the best aberration positions at +90 degrees, +180 degrees, and +270 degrees. In the drawings, suffixes 0, 9, 18, and 27 indicate attitudes of the lens barrel 100A. 0 is for a case of the normal position, 9 is for a case of being rotated by +90 degrees, 18 is for a case of being rotated by +180 degrees, and 27 is for a case of being rotated by +270 degrees. The best aberration position at the normal position (the center position of the vibration reduction lens 102 in a case in which the aberration is minimized (XLC, YLC)) is the position of P₀ in the drawings (XLC0, YLC0). The best aberration position at +90 degrees is the position of P₉ in the drawings (XLC9, YLC9). The best aberration position at +180 degrees is the position of P₁₈ in the drawings (XLC18, YLC18). The best aberration position at +270 degrees is the position of P₂₇ in the drawings (XLC27, YLC27).

After ending the alignment (211), an end notification is transmitted to the lens CPU 103. On the lens CPU 103 side, based on the best aberration position information of four attitudes, best aberration position information at another attitude is computed and interpolated so as to calculate the best aberration position information, according to each of the attitudes (S108).

After completion of interpolation processing according to an attitude of the best aberration position information of the vibration reduction lens 102, the data thereof is stored in the EEPROM 116 as the best aberration position information of the vibration reduction lens 102 at all of the attitudes (S109). Then, the lens barrel 100A is removed from the alignment tool 200A (S110), and the alignment process is ended.

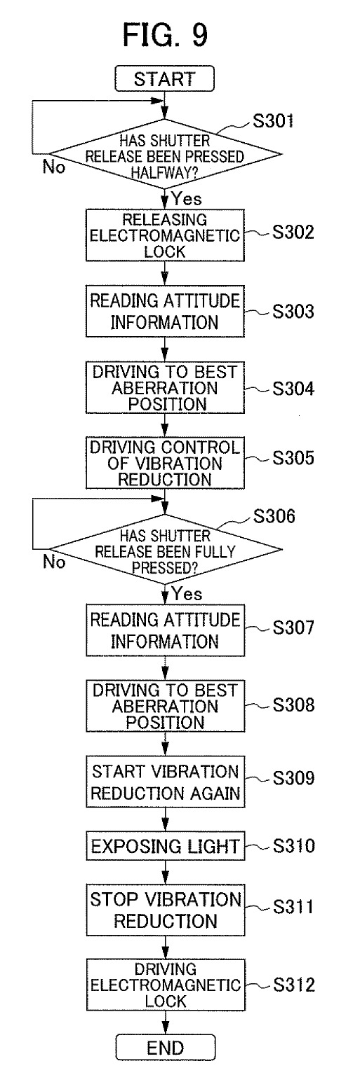

Next, an operation of aberration correction when the vibration reduction SW 115 is in an ON state, using the best aberration position information of the vibration reduction lens 102 that is calculated in the alignment process is described. FIG. 9 is a diagram showing an operational flow of aberration correction when the vibration correction SW 115 is in an ON state.

When the shutter release of a camera is half pressed in a state in which the lens barrel 100A is mounted to the camera (not illustrated) (S301), supply of electric power to the vibration reduction lens 102 is started, and a vibration reduction sequence is started.

First, an electromagnetic lock that mechanically regulates the movement of the vibration reduction lens 102 is released (S302). The attitude information of the current lens barrel 100A is read by the lens CPU 103 (S303). The vibration reduction lens 102 is temporarily driven to the best aberration position at the attitude of the current lens barrel 100A (S304). This best aberration position differs depending on an attitude detected by the attitude detection unit 118: as described above, the position of P₀ (XLC0, YLC0) in FIG. 8 in a case of the normal position; the position of P₉ (XLC9, YLC9) in a case of being rotated by +90 degrees from the normal position; the position of P₁₈ (XLC18, YLC18) in a case of being rotated by +180 degrees from the normal position; the position of P₂₇ (XLC27, YLC27) in a case of being rotated by +270 degrees from the normal position. Furthermore, the best aberration positions at the intermediate positions thereof are the positions computed and interpolated in 5108 of FIG. 7.

Based on the output of the angular velocity sensor 105, drive control of the vibration reduction lens 102 is started so as to steady an image on the imaging surface (S305). When a shutter release of a camera is pressed fully (Yes in 306), attitude information is read again similarly to the abovementioned S303 while a quick return mirror (not illustrated) is springing up.

Furthermore, similarly to the abovementioned S304, the vibration reduction lens 102 is driven to the best aberration position at the attitude position of the lens barrel 100A at the time of the shutter release being fully pressed (S308). Then, after driving to the best aberration position, the vibration reduction is started again (S309).

Vibration reduction is performed, light is exposed at a predetermined shutter speed (S310), and the vibration reduction is stopped (S311). Afterward, the electromagnetic lock is driven (S312), and the operational flow ends. In a case of a half press timer being activated, drive for vibration reduction is performed; however, in a case of the half press timer being deactivated, the electromagnetic lock is driven and the vibration reduction lens 102 is retained mechanically.

Thus, since the vibration reduction is started around the best aberration position obtained in the alignment process so as to perform imaging, it becomes possible to perform imaging at the best position for aberration performance in consideration of optical performance.

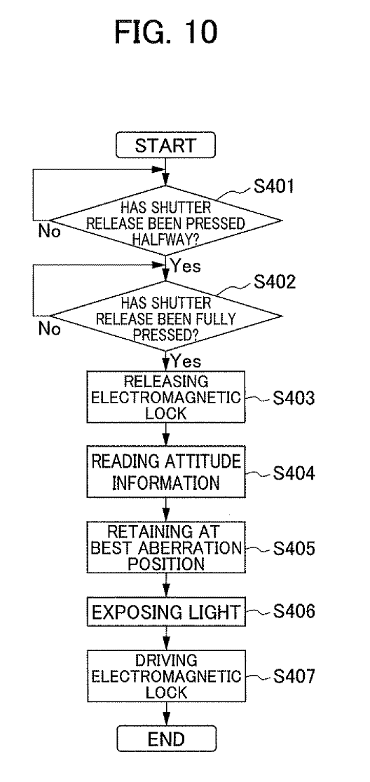

With reference to FIG. 10, operation of aberration correction in a case of the vibration reduction SW 115 being in an OFF state, using the best aberration position information of the vibration reduction lens 102 that is calculated in the alignment process is described.

FIG. 10 is a diagram showing an operational flow of aberration correction when the vibration correction SW is in an OFF state.

When the shutter release of the camera is half pressed (S401) and then fully pressed (S402) in a state in which the lens barrel 100A is mounted to the camera (not illustrated), a quick return mirror (not illustrated) springs up and the electromagnetic lock is released (S403).

The attitude information of the current lens barrel 100A is read by the lens CPU 103 (S404). Then, the vibration reduction lens 102 is driven to the best aberration position at the attitude of the current lens barrel 100A (S405). Similarly to the abovementioned case of the vibration reduction SW115 being in the ON state, this best aberration position differs depending on a current attitude detected by the attitude detection unit 118: the position of P₀ (XLC0, YLC0) in FIG. 8 in a case of the normal position; the position of P₉ (XLC9, YLC9) in a case of being rotated by +90 degrees from the normal position; the position of Pₙ (XLC18, YLC18) in a case of being rotated by +180 degrees from the normal position; and the position of P₂₇ (XLC27, YLC27) in a case of being rotated by +270 degrees from the normal position. Furthermore, the best aberration positions at the intermediate positions thereof are the positions computed and interpolated in 5108 of FIG. 7. Then, light is exposed at a predetermined shutter speed (S406), then the electromagnetic lock is driven (S407), and the operational flow ends.

Thus, even when the vibration reduction SW 115 is in an OFF state, since imaging is performed at the best aberration position obtained in the alignment process, it becomes possible to perform imaging at the best position for aberration performance in consideration of optical performance.

From the above, the present embodiment has the following effects.

(1) The position of the vibration reduction lens 102 at which aberration generated on the imaging surface by the imaging optical system composed of a plurality of the lens units 104 included in the lens barrel 100A is minimized is stored in the lens CPU 103 as a best aberration position that corresponds to an attitude for each of the individual lens barrel 100A. At the time of imaging, imaging is performed after the vibration reduction lens 102 is moved to the best aberration position at the attitude. In this way, since the aberrations that differ depending on the lens barrel 100A are adjusted for each lens barrel 100A, the aberration of each lens barrel can be minimized.

In the present embodiment, for example, the vibration reduction lens 102 is moved to the best aberration position after the attitude of the lens barrel 100A (an angle around the optical axis) is detected by the attitude detection unit 118 as well as before photoelectric conversion is performed by the image pickup device 202. Therefore, aberration of the image that has been captured by the image pickup device 202 can be suppressed. Although the present embodiment is described using the best aberration position, it is not limited thereto. For example, it may be anything that can reduce a small aberration by moving the vibration reduction lens 102.

(2) Furthermore, since the best aberration position fluctuates so that aberration is minimized according to the attitudes, it becomes possible to perform imaging at the best position for aberration performance in consideration of optical performance at each of the attitudes.

(3) Since an existing vibration reduction lens 102 is used, it is not necessary to add new components for aberration correction.

(4) Since vibration reduction is performed with the best aberration position as the center position, it is possible to perform quick vibration correction.

### Modified Embodiment

Without being limited to the second embodiment as described above, various changes and modifications thereto as shown below can be made, and these are also within the scope of the present invention.

(1) In the abovementioned second embodiment, although the configuration is exemplified in which correction of aberration is performed using the vibration reduction lens, the present invention is not limited thereto. Without being limited to the vibration reduction lens, for example, another lens can be used so long as it is a lens that can move in a surface perpendicular to the optical axis, and, for example, it may be a configuration in which a lens for aberration correction is additionally provided.

For example, in a case in which a lens that corrects aberration is a vibration reduction lens, the vibration reduction lens may be drawn back (centering) to a position stored in a storage unit at which aberration is made small. This is because it is possible to perform imaging in a better state of optical characteristic by drawing back the vibration reduction lens to a position at which aberration is made small. Furthermore, by drawing back the vibration reduction lens to a position at which aberration is made small, a drive range in which the vibration reduction lens can be driven can be made substantially large.

Drawing back of the vibration reduction lens may be performed before imaging by the imaging unit (before exposing light) and may be performed during imaging by the imaging unit (while exposing light). Furthermore, the vibration reduction lens is not limited to one that is perpendicular to the optical axis.

For example, in a case in which aberration is corrected using a lens other than the vibration reduction lens, it is preferable to correct aberration by driving the lens that corrects aberration before exposing light and to stop the lens that corrects aberration while exposing light. Since the lens that corrects aberration while exposing light is stopped, it is possible to suppress unwanted image blur.

(2) Although the abovementioned second embodiment is configured in a structure in which the alignment tool is mounted to the lens barrel, the present invention is not limited thereto.

For example, it may be a structure in which the camera has a function of the alignment tool. In this case, the image pickup device of the alignment tool can be used as an image pickup device of the camera.

(3) Although the abovementioned second embodiment is described so that an operator operates the drive amount input unit so as to drive the vibration reduction lens to the best aberration position at which aberration is minimized, the present invention is not limited thereto. For example, it may be configured so that the tool CPU drives the vibration reduction lens to the best aberration position automatically.

(4) In the second embodiment, although measurement of alignment is performed at the normal position, at the position rotated by +90 degrees from the normal position, at the position rotated by +180 degrees from the normal position, and at the position rotated by +270 degrees from the normal position, the present invention is not limited thereto. For example, it is possible to correct aberration with higher accuracy by performing measurement at more than those attitudes.

The abovementioned second embodiment and the modified embodiment can be combined appropriately to be used; however, a detailed explanation thereof is omitted.

In addition, the present invention is not limited to the embodiments described above.

### Third Embodiment

Next, a third embodiment is described. In the third embodiment, portions equivalent to the first embodiment are assigned the same reference numerals and described.

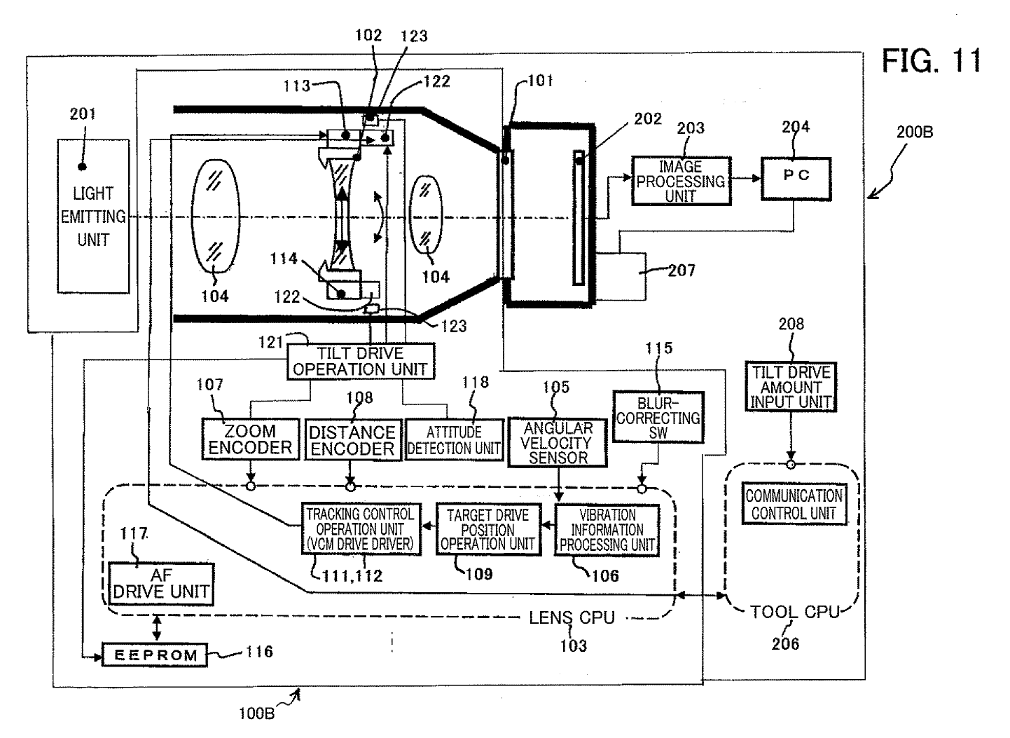

FIG. 11 is a block diagram of a lens barrel 100B and an alignment tool 200B for performing alignment of the lens barrel 100B.

The alignment tool 200B includes a light emitting unit 201 that emits collimated light from an leading end side of the lens barrel 100B and an image pickup device 202 that is mounted to a mounting unit 101 of the lens barrel 100B, receives light emitted from the light emitting unit 201 through the lens barrel 100B, and converts the light to an electric signal by way of photoelectric conversion function.

Furthermore, the alignment tool 200B includes an image processing unit 203 that converts the electric signal obtained from the image pickup device 202 to graphic information, and a tool PC 204 that converts to an aberration amount based on the graphic information obtained by the image processing unit 203 and displays on a screen (on a monitor) (not illustrated).

Furthermore, the alignment tool 200B includes a barrel rotation unit (barrel attitude drive stage) 207 that imparts a predetermined tilt to the lens barrel 100B entirely according to the instruction from the tool PC 204.

Furthermore, the alignment tool 200B includes a tilt drive amount input unit 208 such as a joystick that allows an operator to input an aberration value by viewing the aberration value displayed on the monitor of the tool PC 204. According to a signal inputted from this tilt drive amount input unit 208, a vibration reduction lens 102 is driven in the lens barrel 100B as described later. Although the vibration reduction lens 102 is also used as a vibration reduction lens (hereinafter, referred to as a vibration reduction lens) that corrects image blur due to blur of the lens barrel 100B, it may be arranged to be separate from the vibration reduction lens.

The alignment tool 200B further includes a tool CPU 206 that communicates imaging surface moving distance information of the vibration reduction lens 102 to the lens CPU 103 (described later) based on the signal of the tilt drive amount input unit 208.

This communication is performed via an electrode (not illustrated) provided to the mounting unit 101 of the lens barrel 100B. Furthermore, the tool CPU 206 supplies electric power in order to drive the lens CPU 103 and the vibration reduction lens 102 via an electrode (not illustrated). In addition, the tool CPU 206 loads from the lens CPU 103 information of a zoom encoder 107 in the lens barrel 100B and extension amount information of lens units 104 and 104 (information of a distance encoder 108) and information of an attitude detection unit 118 in a case of zooming, as described later.

Moreover, the lens barrel 100B, as an imaging optical system, includes the vibration reduction lens 102 that corrects blur of an image on the image pickup device 202 and the lens units 104 and 104 that move while zooming, and further includes the lens CPU 103 that communicates with the tool CPU 206 as described above.

The lens CPU 103 includes therein a program for an alignment mode to perform alignment. When the lens barrel 100B is mounted to the alignment tool 200B, the lens CPU 103 identifies a connection state by communication with the tool CPU 206, and transitions to the alignment mode. With the transition to the alignment mode, it becomes possible to drive and control the vibration reduction lens 102 based on the imaging surface moving information of the vibration reduction lens 102 that is transmitted from the tool CPU 206.

The lens barrel 100B includes an angular velocity sensor 105 that detects an angular velocity. An output of the angular velocity detected by the angular velocity sensor 105 passes through a low pass filter (LPA)+amplifier unit (not illustrated) so that an unwanted high-frequency noise is removed, and is inputted to a vibration information processing unit 106. The angular velocity sensor 105 does not function in the alignment mode. The vibration information processing unit 106 extracts blur information necessary for image blur correction based on information of the angular velocity sensor 105.

Furthermore, the lens barrel 100B includes the attitude detection unit 118 composed of a triaxial acceleration sensor and the like for detecting an attitude of the lens barrel 100B. This attitude detection sensor 118 detects tilt composed of a pitching angle and a rolling angle of the lens barrel 100B based on an output of the triaxial acceleration sensor. Herein, tilt indicates a change in inclination of a vertical axis and an optical axis passing through the center of the lens barrel 100B, and changes positively and negatively with an optical axis position being set as zero. The attitude detection unit 118 may be embedded in a camera main body (described later) that is coupled via the mounting unit 101. In addition, regarding the attitude detection unit 118, any type of sensor may be acceptable so long as it can detect an attitude other than the triaxial acceleration sensor.

Furthermore, the lens barrel 100B includes the zoom encoder 107, the distance encoder 108, and a target drive position operation unit 109 that performs calculation of a target drive position of the vibration reduction lens 102 based on the outputs of the vibration information processing unit 106.

In the target drive position operation unit 109, the imaging surface moving information of the vibration reduction lens 102 that is transmitted from the tool CPU 206 is converted to moving distance information of the vibration reduction lens 102 based on anti-vibration correction coefficient information that is stored in EEPROM 116. Herein, the anti-vibration correction coefficient information is information of a ratio between a moving distance of the vibration reduction lens 102 and a moving distance of an image according to the movement of the vibration reduction lens 102, and is retained as matrix information in which the inputs to the zoom encoder 107 and the distance encoder 108 are used as parameters. Furthermore, an alignment adjustment value that is transmitted from the tool CPU 206 is converted to lens position information in the target drive position operation unit 109, and is stored in the EEPROM 116.

Furthermore, the lens barrel 100B includes a tracking control operation unit 111 that performs a tracking control operation of the vibration reduction lens 102 based on target drive position information calculated at the target drive position operation unit 109, and a VCM drive driver 112 that supplies electric power to a VCM 113 (voice coil motor) according to a signal from the tracking control operation unit 111. The VCM 113 is an electromagnetic-driven actuator composed of a coil and a magnet to generate drive power by flowing electric current to the coil.

This VCM 113 allows the vibration reduction lens 102 to drive within a level plane that is perpendicular to the optical axis. The drive unit is not limited to the VCM 113 and may be a PZT (lead zirconate titanate) type actuator such as SIDM (Smooth Impact Drive Mechanism) or S™ (stepping motor).

Furthermore, the lens barrel 100B includes a position detection unit 114 that detect a position of the vibration reduction lens 102. A method of using a PSD (Position Sensitive Detector) is common for position detection. The position of the vibration reduction lens 102 obtained at the position detection unit 114 is fed back to the tracking control operation unit 111. The position detection unit 114 is not limited to the abovementioned PSD, and may be a position detection unit 114 that detects a fluctuation of magnetic flux density using a magnet and a Hall element.

Furthermore, the lens barrel 100B includes a vibration reduction SW 115 that is a switch to select an ON/OFF state of driving of a vibration reduction lens 102 by a user. When the vibration reduction SW 115 is in an ON state, the vibration reduction lens 102 is driven by the VCM 113 within the level plane that is perpendicular to the optical axis so as to negate image blur on the imaging surface (on the image pickup device 202) due to blur of the lens barrel 100B (for example, blur generated by hand movement), according to an output of the angular velocity sensor 105. When the vibration reduction SW 115 is in an OFF state, the vibration reduction lens 102 is fixed by a locking mechanism (not illustrated) at a position where centers thereof coincide with each other. Furthermore, the lens barrel 100B includes an AF (auto focus) drive unit 117 that performs focusing on an object (not illustrated) automatically.

In addition, the lens barrel 100B includes a tilt drive unit 122 that drives the vibration reduction lens 102 to be tilted using a point on the optical axis as a fulcrum, a tilt drive operation unit 121 for tilting the vibration reduction lens 102 via this tilt drive unit 122, and a position detection unit 123 (hereinafter, tilt position detection unit 123) of the tilt drive unit 122 for detecting a position of the tilt drive unit 122. It is also possible to configure the tilt drive unit 122 so that the vibration reduction lens 102 is caused to rotate in an in-plane direction including the optical axis of the imaging optical system.

This tilt drive operation unit 121 instructs a target value of the tilt drive unit 122 to the tilt drive unit 122 based on the information from the EEPROM 116. The value of the EEPROM 116 as referred to above is composed of attitude information of the attitude detection unit 118 upon the barrel rotation unit 207 being inclined by the tool PC 204 of the alignment tool 200B, zooming information of the zoom encoder 107 set at that time, and position information of the tilt position detection unit 123 upon aberration on the image pickup device being set to no more than a predetermined value. Then, the value of the EEPROM 116 is also composed of information obtained by the alignment tool 200B before factory shipment for each lens barrel 100B and written by way of the tool PC 206 to the EEPROM 116 of the lens barrel 100B.

The tilt drive unit 122 drives the vibration reduction lens 102 to be tilted using a point on the optical axis of the lens barrel 100B as a fulcrum based on the position information of the attitude detection unit 118 and the vibration reduction lens 102. In the present embodiment, a multilayered PZT is used for the tilt drive unit 122.

For example, in order to perform tilt correction of 10′ (“minute” of arc), in a case of the diameter of the vibration reduction lens 102 being 20 mm, it is necessary to move the vibration reduction lens 102 by 14 micrometer using a point on the optical axis as a fulcrum. The multilayered PZT can easily perform displacement of about 14 micrometer. Even if the tilt correction angle is identical at 10′, if the diameter of the vibration reduction lens 102 is smaller, the drive amount of the tilt drive unit 122 will naturally become smaller.

In addition, the tilt drive unit 122 and the tilt position detection 123 are disposed at two locations, respectively, so as to allow driving thereof in both plus or minus directions with respect to a neutral axis of the vibration reduction lens 102.

Furthermore, the tilt drive unit 122 and the tilt position detection unit 123 allow the vibration reduction lens 102 to be inclined in an arbitrary direction by disposing in two axes that are perpendicular within a plane that is perpendicular to the optical axis of the vibration reduction lens 102.

Moreover, since the multilayered PZT contains hysteresis, it performs position detection sequentially at the tilt position detection unit 123 and performs feedback control at the tilt drive unit 122.

Not only the multilayered PZT, but also VCM, STM, and the like can be used in the tilt drive unit 122. An STM can perform open control and thus has an advantage in that the tilt position detection unit 123 is not necessary.

Furthermore, although the tilt position detection unit 123 that detects a position of the tilt drive unit 122 uses PSD in the present embodiment, the present invention is not limited to a PSD, and may use a unit for detecting a fluctuation of density of magnetic flux employing a magnet and Hall element.

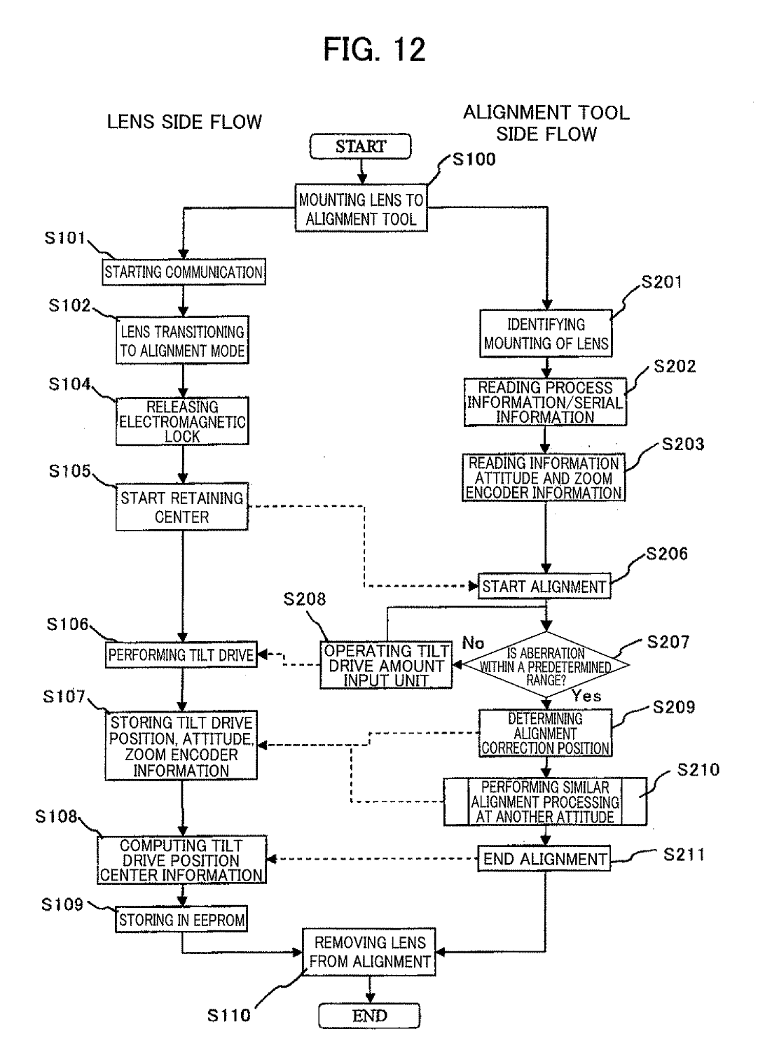

Next, alignment operation is described with reference to FIGS. 11 and 12. FIG. 12 illustrates an alignment operation flow using an alignment tool.

An operator mounts the lens barrel 100B to the alignment tool 200B (S100). After mounting, the alignment tool 200B identifies mounting of the lens barrel 100b (S201) and supplies electric power to the lens barrel 100B side.

The lens CPU 103 starts communication with the tool CPU 206 at the lens barrel 100B (S101). The lens CPU 103 includes a program for an alignment mode for alignment as described above and, when the lens CPU 103 detects that it is mounted to the alignment tool 200B, it transitions to the alignment mode (S102).

Furthermore, the lens CPU 103 includes process information and serial information of the lens barrel 100B, and allows the tool PC 206 to read the information so as to perform management of adjustment inspection process by the tool PC 206.

The alignment tool 200B drives the AF drive unit 117 in the lens barrel 100B and instructs the focus lens unit (not illustrated) to be driven to a predetermined focusing position. The focusing lens unit is moved to a predetermined position according to the instruction. This predetermined focusing position is a predetermined start position such as an infinity position.

The lens barrel 100B releases an electromagnetic lock (not illustrated) before driving the vibration reduction lens 102 (S104). The electromagnetic lock is a locking mechanism for fixing the vibration reduction lens 102 to a predetermined position. By releasing this electromagnetic lock, it becomes possible to drive the vibration reduction lens 102 by the drive power of the VCM 113 or the tilt drive unit 122.

The alignment tool 200B reads from the lens CPU 103 information such as position information from the zoom encoder 107 or attitude information from the attitude detection unit 118, and obtains attitude information of the lens barrel 100B. The reading of this attitude information is performed by the tool CPU 206 receiving it from the lens CPU 103 via a contact point of the mounting unit 101 of a lens side. When the lens barrel 100B is not at the normal position, for example, an operator is instructed via the monitor of the tool PC 204 to move the lens barrel 100B to the normal position by operating the tool PC 204 and the barrel rotation unit 207.

The lens barrel 100B starts tracking control by setting center position information that the EEPROM 116 includes to a target drive position of the vibration reduction lens 102. When moving to the center position (105), a signal indicating that alignment can be operated is transmitted to the tool CPU 206 of the alignment tool 200B.

The alignment tool 200B starts alignment when receiving the signal indicating that alignment can be operated from the lens barrel 100B (S206). The alignment is performed with the optical axis being set as a rotation axis, at a normal position (0 degrees) and positions rotated by +45 degrees, +90 degrees, +135 degrees, +180 degrees, +225 degrees, +270 degrees (−90 degrees), +315 degrees (−45 degrees), respectively, according to the attitude of the lens barrel 100B. Furthermore, regarding a vertical direction, the alignment is performed at five positions including a normal position and positions of the optical axis including 45 degrees downward, 90 degrees downward, 45 degrees upward, and 90 degrees upward. Thus, the alignment is performed at 40 positions (8×5) at a single zooming position and is performed at all of the predetermined zooming positions (120 positions, 8×5×3)(for example, a wide end state W, an intermediate focusing distance state M, a tele end state T, and the like). The positions of the alignment are not limited to 40 positions (8×5) at a single zooming position and may be appropriately increased or decreased. Furthermore, the zooming positions are not limited to the three positions including the wide end state W, the intermediate focusing distance state M, the tele end state T, and may be appropriately increased or decreased.

The operator observes, via the monitor of the tool PC 204, an extent of aberration based on an image of light that is emitted from the light emitting unit 201, passing through the lens barrel 100B, and entering the image pickup device 202, and determines whether the aberration is within a predetermined range (S207). In a case in which the aberration is not within a predetermined range (No in S207), the operator operates the tilt drive amount input unit 208 (S208) and drives the vibration reduction lens 102 to be tilted to a best aberration position at which an aberration is minimized (S106). The tilt drive amount input unit 208 outputs to the lens barrel 100B side a tilt drive amount of the vibration reduction lens 102 that is driven to be tilted via the tool PC 206.

The tilt drive amount information transmitted from the tool CPU 206 is converted to a position of the vibration reduction lens 102 at the tilt drive operation unit 121, and the vibration reduction lens 102 is driven to be tilted via the tilt drive unit 122 so as to modify a tilt position of the vibration reduction lens 102 (S106).

In a case in which the aberration is within the predetermined range (Yes in S207), a signal of an alignment correction position determination is transmitted to the lens CPU 103 side (S209). After receiving the signal of the alignment correction position determination, the lens CPU 103 side transmits to the lens CPU 103 alignment information of the vibration reduction lens 102, lens attitude information at that time, and zoom encoder information, and stores those in the RAM (not illustrated) (s107).

When adjustment at the normal position ends, a similar adjustment is performed at another lens attitude and another zooming position (S210). The lens CPU 103 stores tilt position information for each position in the RAM (S107).

After ending the alignment (211), an end notification is transmitted to the lens CPU 103. On the lens CPU 103 side, based on the best aberration position information at each alignment process, best aberration position information at another attitude is computed for interpolation (for example, least-square method) so as to calculate best aberration position information according to each of the attitudes. By way of these processes, the best aberration position information after driving for tilting according to each of the lens attitudes and zooming positions can be determined (S108).

After completion of interpolation processing according to an attitude of best aberration position information of the vibration reduction lens 102, the result thereof is stored in the EEPROM 116 as the best aberration position information of the vibration reduction lens 102 at all of the attitudes (S109). Then, the lens barrel 100B is removed from the alignment tool 200B (S110), and the alignment process ends. In a case in which the entire amount of the attitude data including attitude data by way of computation for interpolation stored in the EEPROM 116 becomes excessive, only the best aberration position information of measurement data obtained by the alignment (except for data of computation for interpolation) may be stored in the EEPROM 116, and position information corresponding to attitudes of the lens barrel 100B at each point in time may be computed for interpolation at the lens CPU 103 based on given information that has been stored so as to control driving for tilting.

Next, an operation of aberration correction when the vibration reduction SW 115 is in an ON state, using the best aberration position information of the vibration reduction lens 102 in a state in which the lens barrel 100B is mounted to a camera is described.

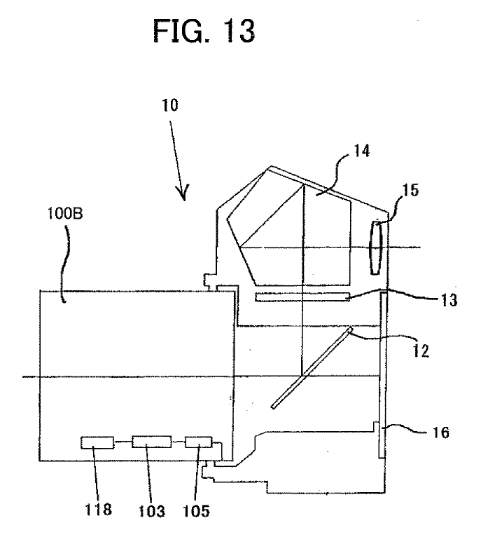

FIG. 13 shows a schematic configuration of a camera that mounts to the lens barrel 100B according to the third embodiment.

In FIG. 13, light from an object (not illustrated) is focused in the lens barrel 100B and reflected by the quick return mirror 12 so as to provide an image to a focusing board 13. The image of the object provided to the focusing board 13 is multiply reflected by a pentaprism 14 and formed so as to be observable as an erected image by a user via an eye lens 15.

The user fully presses a shutter release button (not illustrated) after observing an image of the object via the eye lens 15 while the shutter release button is half pressed and having decided a composition for photographing. When fully pressing the shutter release button, the quick return mirror 12 is upwardly sprung up, a shutter (not illustrated) operates, light from the object is received at the image pickup device 16, an image that was captured is obtained, and it is stored in memory (not illustrated).

When fully pressing the shutter release button, an attitude and blur of the lens barrel 100B of the camera 10 are detected by the attitude detection unit 118 and the angular velocity sensor 105 that are embedded in the lens barrel 100B, and information thereof is transmitted to the lens CPU 103. The lens CPU 103 corrects aberration due to image blur and change of attitude on the image pickup device 16 by driving the vibration reduction lens 102 in a direction perpendicular to the optical axis and driving it to be tilted via the VCM 113 and the tilt drive unit 122 shown in FIG. 11.

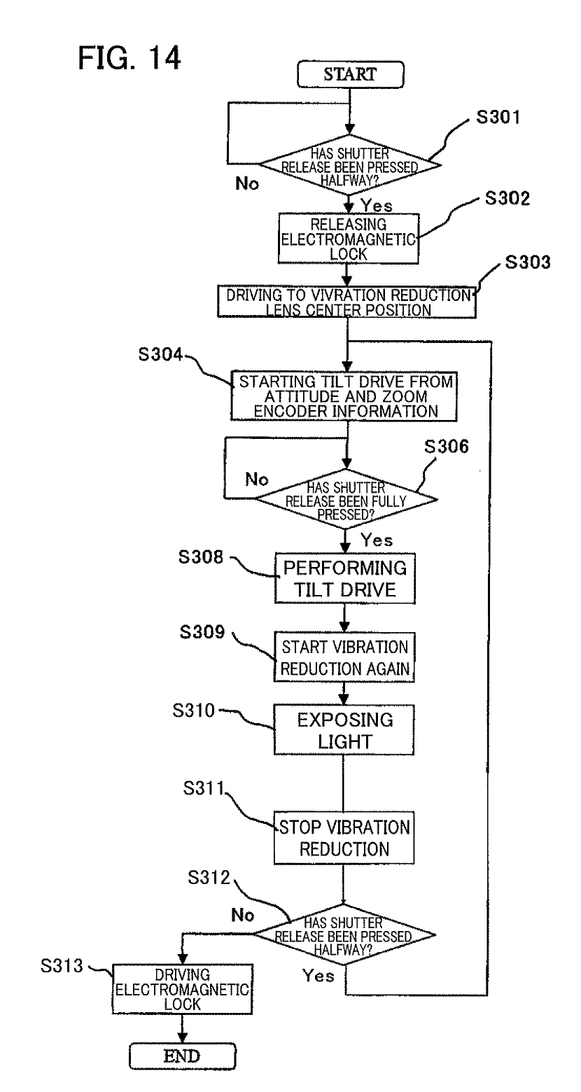

FIG. 14 is a diagram showing an operational flow of aberration correction when the vibration correction SW 115 is in an ON state.

When the shutter release of the camera 10 is half pressed in a state in which the lens barrel 100B is mounted to the camera 10 shown in FIG. 13 (S301), supply of electric power to the vibration reduction lens 102 is started, and a vibration reduction sequence is started.

First, an electromagnetic lock that mechanically regulates the movement of the vibration reduction lens 102 is released (S302).

The vibration reduction lens 102 is driven to a control center position (S303). The center position at that time is not a position of the tilt position detection unit 123, but is information from the position detection unit 114 of the vibration reduction lens 102.

Shift drive and tilt drive control of the vibration reduction lens 102 is started so that aberration on a surface of the image pickup device 16 is minimized based on information from the angular velocity sensor 105, the attitude detection unit 118, and the zoom encoder 107. At this time, drive control is started so that the vibration reduction lens 102 is placed at the best aberration position among attitudes of the current lens barrel 100B (S304).

This state stands by for input of a signal for fully pressing the shutter release (S 306).

When the shutter release of the camera 10 is pressed fully (Yes in 306), the vibration reduction lens 102 is driven to be tilted to the best aberration position based on attitude information and zooming information while the quick return mirror (not illustrated) is springing up. After driving for tilting, vibration reduction is started again (S309).

The vibration reduction is performed, light is exposed at a predetermined shutter speed (S310), and the vibration reduction is stopped (S311). Afterward, if a half press timer is activated (Yes in S312), anti-vibration and tilt drive after S304 are performed; if the half press timer is deactivated (No in S312), the electromagnetic lock is driven, the vibration reduction lens 102 is retained mechanically (S313), and the operational flow ends.

Thus, since the vibration reduction and tilt correction are performed around the best aberration position obtained in the alignment process so as to perform imaging, it becomes possible to perform imaging at the best state for aberration performance in consideration of optical performance.

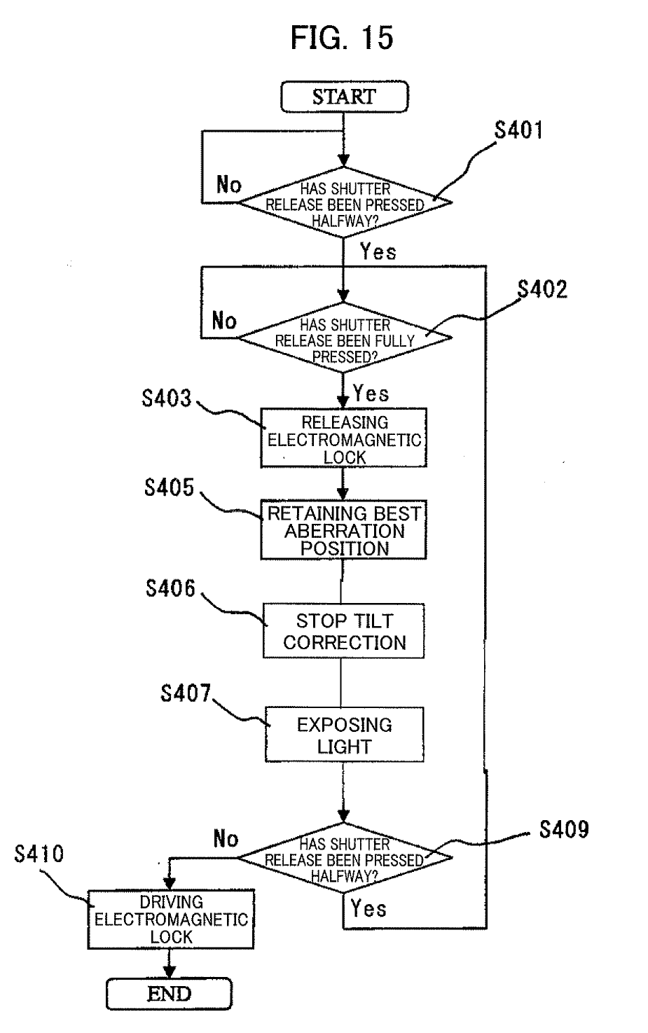

Next, operation of aberration correction when the vibration reduction SW 115 is in an OFF state, using the best aberration position information of the vibration reduction lens 102 that is calculated in the alignment process is described with reference to FIG. 15. FIG. 15 is a diagram showing an operational flow of aberration correction when the vibration correction SW is in an OFF state.

When the shutter release of a camera is half pressed (S401) and then fully pressed (S402) in a state in which the lens barrel 100B is mounted to the camera 10 shown in FIG. 13, a quick return mirror 12 springs up and the electromagnetic lock is released (S403).

The attitude information of the current lens barrel 100B is read by the lens CPU 103 (S404). The vibration reduction lens 102 is driven to be tilted to the best aberration position at the attitude of the current lens barrel 100B (S405). Similarly to the abovementioned case of the vibration reduction SW115 being in the ON state, this best aberration position differs depending on a current attitude of the lens barrel 100B detected by the attitude detection unit 118 and the zoom encoder 107, an attitude is detected by the lens CPU 103, and the best aberration position of the vibration reduction lens 102 for tilt correction is calculated. After performing tilt-drive and stopping the vibration reduction lens 102 (S406), light is exposed at a predetermined shutter speed (S407). Afterward, if a half press timer is activated (Yes in S409), tilt drive after S402 is performed; if the half press timer is deactivated (No in S409), the electromagnetic lock is driven, the vibration reduction lens 102 is retained mechanically (S410), and the operational flow ends.

Thus, even when the vibration reduction SW 115 is in an OFF state, since imaging is performed at the best aberration position by the tilt correction obtained in the alignment process, it becomes possible to perform imaging at the best position for aberration performance in consideration of optical performance.

From the above, the present embodiment has the following effects.

(1) The position of the vibration reduction lens 102 at which an aberration generated on the imaging surface by the imaging optical system composed of a plurality of the lens units 104 and 104 included in the lens barrel 100B is minimized is stored in the EEPROM 116 as a best aberration position that corresponds to an attitude for each of the individual lens barrel 100B, and computation for interpolation processing is performed by the lens CPU 103. At the time of imaging, imaging is performed after the vibration reduction lens 102 is moved to the best aberration position at the attitude. In this way, since aberration differing depending on the lens barrels 100B is adjusted for each lens barrel 100B, the aberration of each lens barrel can be minimized so that high imaging performance can be achieved.

(2) Furthermore, regarding the best aberration position, since a position of the vibration reduction lens 102 is changed so that aberration is minimized according to the attitude, it becomes possible to perform imaging at the best state for aberration performance in consideration of optical performance at each of the attitudes.

(3) Since it can be achieved by adding a tilt drive and a detection means to the current vibration reduction lens 102, it can be accommodated with few modifications.

(4) Since vibration reduction is performed with the best aberration position set as the center position, it is possible to perform quick vibration correction.

### Modified Embodiment

Without being limited to the third embodiment as described above, various changes and modifications thereto as shown below can be made, and these are also within the scope of the present invention.

(1) In the abovementioned third embodiment, although the configuration is exemplified in which correction of aberration is performed using the vibration reduction lens, the present invention is not limited thereto. Without being limited to the vibration reduction lens, for example, another lens can be used so long as it is a lens that can move to be tilted with respect to the optical axis, and, for example, it may be a configuration in which a lens for aberration correction is additionally provided.

For example, in a case in which the lens that corrects aberration is a vibration reduction lens, the vibration reduction lens may be drawn back (centering) to a position stored in a storage unit at which aberration is made small. This is because it is possible to perform imaging in a better state of optical characteristics by drawing back the vibration reduction lens to a position at which aberration is made small. Furthermore, by drawing back the vibration reduction lens to a position at which aberration is made small, a drive range in which the vibration reduction lens can be driven can be made substantially large.

Drawing back of the vibration reduction lens may be performed before imaging by the imaging unit (before exposing light), and may be performed during imaging by the imaging unit (while exposing light). Furthermore, the vibration reduction lens is not limited to one that is perpendicular to the optical axis.

For example, in a case in which aberration is corrected using a lens other than the vibration reduction lens, it is preferable to correct aberration by driving the lens that corrects aberration before exposing light and to stop the lens that corrects aberration while exposing light. Since the lens that corrects aberration is stopped during light exposure, it is possible to suppress unwanted image blur.

(2) Although the abovementioned third embodiment is configured in a structure in which the alignment tool is mounted to the lens barrel, the present invention is not limited thereto.

For example, it may be a structure in which the camera has a function of the alignment tool. In this case, the image pickup device of the alignment tool can be used as the image pickup device of the camera.

(3) Although the abovementioned second embodiment is described so that an operator operates the tilt drive amount input unit so as to drive the vibration reduction lens to be tilted to the best aberration position at which aberration is minimized, the present invention is not limited thereto. For example, it may be configured so that the tool CPU drives the vibration reduction lens to the best aberration position automatically.

(4) In the third embodiment, although alignment is performed, with the optical axis being set as a rotation axis, at a normal position (0 degrees) and positions rotated by +45 degrees, +90 degrees, +135 degrees, +180 degrees, +225 degrees, +270 degrees (−90 degrees), +315 degrees (−45 degrees), at a normal position and positions of 45 and 90 degrees upward and 45 and 90 degrees downward regarding a vertical direction, and at three positions including the wide end state W, the middle focusing distance state M, and the tele end state T (120 positions of total), respectively, the present invention is not limited thereto. For example, it is possible to correct aberration with higher accuracy by performing measurement at more than those attitudes.

The abovementioned third embodiment and the modified embodiment can be combined appropriately to be used; however, a detailed explanation thereof is omitted. In addition, the present invention is not limited to the embodiments described above.

### Fourth Embodiment

Next, a fourth embodiment is described.

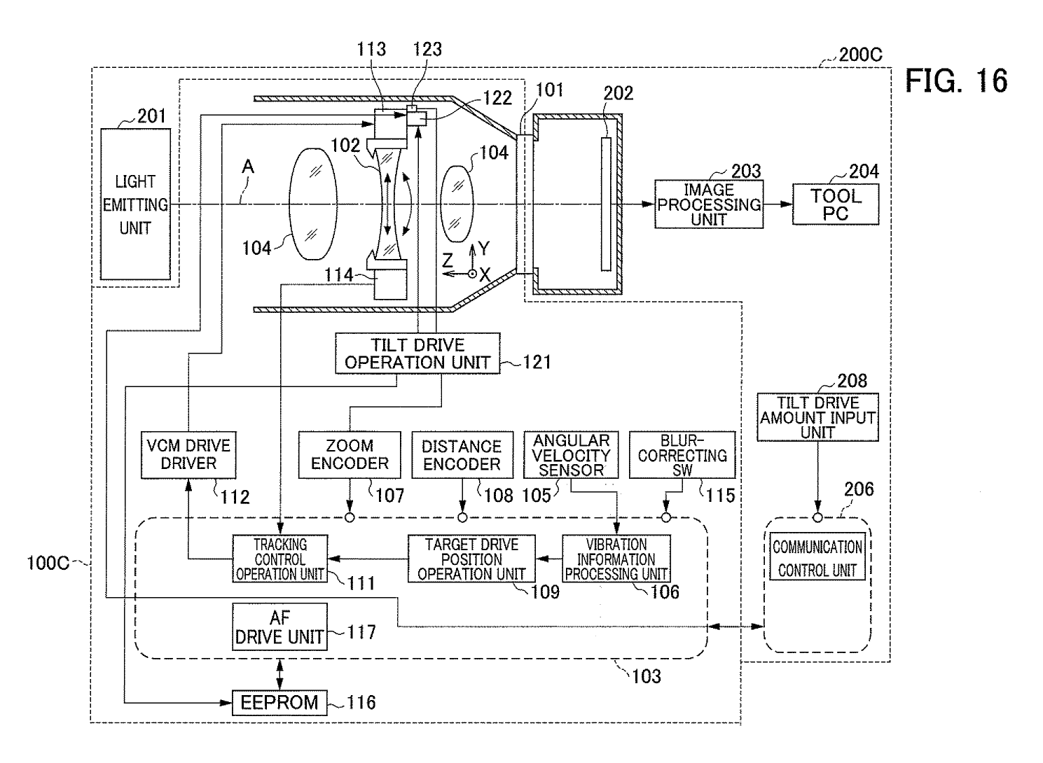

In the fourth embodiment, portions equivalent to the first embodiment are assigned the same reference numerals and described. In the fourth embodiment, a Cartesian coordinate system of XYZ is provided in FIG. 16 for facilitating understanding and explanation. In this coordinate system, a direction toward a left side as viewed by a user, in a camera position in a case in which the user captures a horizontally long image, with the optical axis being made in a horizontal direction (hereinafter, referred to as a normal position), is deemed to be an X-plus direction. Furthermore, a direction toward an upper side in a normal position is deemed to be a Y-plus direction. Furthermore, a direction toward an object in a normal position is deemed to be a Z direction. FIG. 16 shows a state in which the lens barrel 100C is mounted to the alignment tool 200C; however, the above coordinate system shows a direction in a case in which the lens barrel 100C is mounted to a camera main body (not illustrated). Furthermore, in the lens shown in the drawings, a straight arrow indicates the direction of shift drive and the circular arc arrow indicates the direction of tilt drive.

FIG. 16 is a system configuration diagram of a lens barrel 100C and an alignment tool 200C for performing alignment of the lens barrel 100C. The alignment tool 2000 includes a light emitting unit 201 that emits collimated light from a leading end side of the lens barrel 100C, and an image pickup device 202 that is mounted to a mounting unit 101 of the lens barrel 100C, receives light emitted from the light emitting unit 201 and passing through the lens barrel 100C, and converts the light to an electric signal by way of photoelectric conversion function. This image pickup device 202 is disposed within a housing, which is in the shape of the camera main body. Furthermore, the alignment tool 200C includes an image processing unit 203 that converts the electric signal obtained from the image pickup device 202 to graphic information, and a tool PC 204 that converts to an aberration amount based on the graphic information obtained by the image processing unit 203 and displays on a screen.

In addition, the alignment tool 200C includes a tilt drive amount input unit 208 such as a joystick that allows an operator to input an aberration value by viewing the aberration value displayed on the monitor of the tool PC 204. According to a signal inputted from this tilt drive amount input unit 208, a vibration reduction lens 102 is driven in the lens barrel 100C as described later.

The alignment tool 2000 further includes a tool CPU 206 (including a communication control unit) that communicates imaging surface moving distance information of the vibration reduction lens 102 to the lens CPU 103 based on the signal from the tilt drive amount input unit 208. This communication is performed via the mounting unit 101 of the lens barrel 100C. In addition, the tool CPU 206 supplies electric power in order to drive the lens CPU 103 and the vibration reduction lens 102. Furthermore, the tool CPU 206 loads from the lens CPU 103 information of a zoom encoder 107 in the lens barrel 100C and extension amount information of lens units 104 (information of a distance encoder 108) in a case of focusing.

On the other hand, the lens barrel 100C, as an imaging optical system, includes the vibration reduction lens 102 that corrects blur of an image and the lens unit 104 that moves while zooming, and further includes the lens CPU 103 that communicates with the tool CPU 206 as described above. The lens CPU 103 includes therein a program for an alignment mode to perform alignment. When the lens barrel 100C is mounted to the alignment tool 200C, the lens CPU 103 identifies a connection state by communication with the tool CPU 206, and transitions to the alignment mode. With the transition to the alignment mode, it becomes possible to drive and control the vibration reduction lens 102 based on the imaging surface moving information of the vibration reduction lens 102 that is transmitted from the tool CPU 206.

The lens barrel 100C further includes an angular velocity sensor 105 that detects an angular velocity. An output of an angular velocity detected by the angular velocity sensor 105 passes through an LPF+amplifier unit (not illustrated) so that an unwanted high-frequency noise is removed, and is inputted to a vibration information processing unit 106. The angular velocity sensor 105 does not function in the alignment mode. The vibration information processing unit 106 extracts blur information to be corrected based on information of the angular velocity sensor 105.

In addition, the lens barrel 100C includes the zoom encoder 107, the distance encoder 108, and a target drive position operation unit 109 that performs calculation of a target drive position of the vibration reduction lens 102 based on the outputs of the vibration information processing unit 106.

Furthermore, the lens barrel 100C includes a tracking control operation unit 111 that performs a tracking control operation of the vibration reduction lens 102 based on target drive position information calculated at the target drive position operation unit 109 and outputs a drive signal corresponding to this operation result, and a VCM drive driver 112 that supplies electric power to a VCM 113 (voice coil motor) according to the drive signal from the tracking control operation unit 111. The VCM 113 is an electromagnetic-driven actuator composed of a coil and a magnet to generate drive power by flowing electric current to the coil.

The vibration reduction lens 102 is caused to be driven for shifting within a level plane that is perpendicular to the optical axis A by drive power generated by this VCM 113. Drive of the vibration reduction lens 102 is not limited to the VCM 113 and may be a PZT (lead zirconate titanate) type actuator such as SIDM (Smooth Impact Drive Mechanism) or S™ (stepping motor).

The lens barrel 100C includes a position detection unit 114 that detects a position within the level plane that is perpendicular to the optical axis A of the vibration reduction lens 102. The position information of the vibration reduction lens 102 obtained at this position detection unit 114 is fed back to the tracking control operation unit 111. In the present embodiment, a method of using a PSD (Position Sensitive Detector) is performed for position detection. However, the position detection unit 114 is not limited to the abovementioned PSD and may be a position detection unit 114 that detects a fluctuation of magnetic flux density using a magnet and a Hall element.

The lens barrel 100C includes a vibration reduction SW 115 which is a switch that can select an ON/OFF state of vibration reduction by a user. In an ON state of the vibration reduction, the vibration reduction lens 102 moves in the level plane that is perpendicular to the optical axis so as to negate image blur according to an output of the angular velocity sensor 105. In an OFF state of the vibration reduction, the vibration reduction lens 102 is fixed by a locking mechanism (not illustrated) at a position where centers thereof coincide with each other. Furthermore, the lens barrel 100C includes the EEPROM 116 as a storage unit, RAM (not illustrated), and the AF drive unit 117 that performs focusing.

Furthermore, the lens barrel 100C includes a tilt drive unit 122 that drives the vibration reduction lens 102 to be tilted (inclined) about an axis that is substantially perpendicular to the optical axis A, a tilt drive operation unit 121 for tilt the vibration reduction lens 102 via this tilt drive unit 122, and a position detection unit 123 (hereinafter, tilt position detection unit 123) of the tilt drive unit 122 for detecting a position of the tilt drive unit 122.

This tilt drive operation unit 121 computes a target value for driving the vibration reduction lens 102 to be tilted based on the information stored in the EEPROM 116 and instructs the target value to the tilt drive unit 122. The information of the EEPROM 116 as referred to above is composed of zooming information of the zoom encoder 107 at each of the focusing distances in a case in which the lens barrel 100C that is mounted to the alignment tool 2000 is zoomed, and tilt position information of the tilt position detection unit 123 in a case in which aberration of the image pickup device 202 is caused to decrease so as to be no more than a predetermined value. The information is obtained by the alignment tool 200C before factory shipment for each lens barrel 100C and written by way of the tool PC 206 to the EEPROM 116 of the lens barrel 100C.

The tilt drive unit 122 drives the vibration reduction lens 102 to be tilted about an axis that is substantially perpendicular to the optical axis A of the lens barrel 100C based on the target value from the tilt drive operation unit 121. In the present embodiment, multilayered PZT is used for the tilt drive unit 122.

For example, in order to perform tilt correction of 10′ (minute of arc), in a case of the diameter of the vibration reduction lens 102 being 20 mm, it is necessary to move the vibration reduction lens 102 by 14 micrometer about an axis that is substantially perpendicular to the optical axis A. The multilayered PZT can easily perform displacement about 14 micrometers. Even if the tilt correction angle is identical at 10′, if the diameter of the vibration reduction lens 102 is smaller, the drive amount of the tilt drive unit 122 will naturally becomes smaller.

Furthermore, the tilt drive unit 122 and the tilt position detection unit 123 allows the vibration reduction lens 102 to be tilted in an arbitrary direction by disposing those with respect to two axes that are substantially perpendicular to the optical axis A of the vibration reduction lens 102. In FIG. 16, for convenience of reference to the drawings, although a tilt direction is shown as the z direction, it is also driven to be tilted in the x direction.

Furthermore, since the multilayered PZT includes hysteresis, position feedback is needed. Therefore, a drive at the tilt drive unit 122 is controlled by performing position detection sequentially at the tilt position detection unit 123 and feeding back the position detection information to the tilt drive operation unit 121. Not only the multilayered PZT but also VCM, STM, and the like can be used for the tilt drive unit 122. Since STM can perform open control, it has an advantage in that the tilt position detection unit 123 is not necessary. Furthermore, although the tilt position detection unit 123 performs position detection by using a PSD in the present embodiment, the present invention is not limited to a PSD and may use a unit for detecting a fluctuation of density of magnetic flux employing a magnet and Hall element.

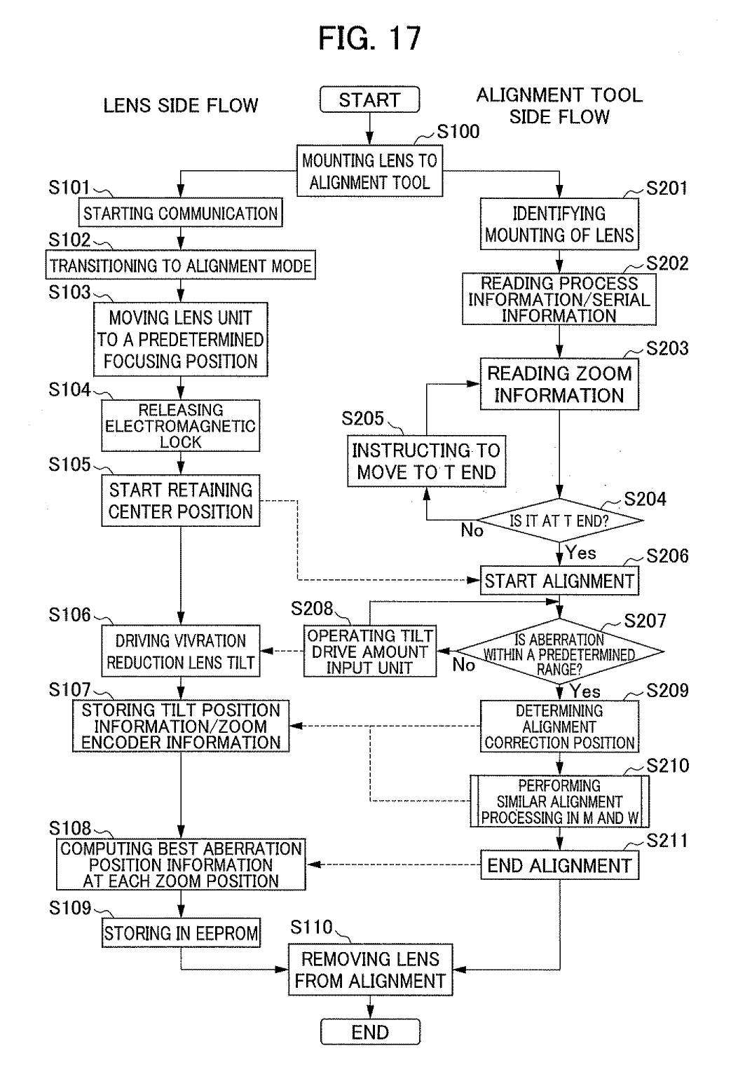

Next, operation during alignment is described. FIG. 17 is a flowchart showing an operating procedure during alignment. First, the lens barrel 100C is mounted to the alignment tool 200C (S100). Then, the alignment tool 200C identifies mounting of the lens barrel 100C (S201) and supplies electric power to the lens barrel 100C side.

On the other hand, at the lens barrel 100C (S101), the lens CPU 103 starts communication with the tool CPU 206. The lens CPU 103 includes a program for an alignment mode for alignment as described above and, when the lens CPU 103 detects that it is mounted to the alignment tool 200C, it transitions to the alignment mode (S102).

Furthermore, the lens CPU 103 includes process information and serial information of the lens barrel 100C. By the tool PC 206 reading the information, it becomes possible to perform management of an adjustment inspection process by the tool PC 206 (S202).

The alignment tool 200C instructs the lens unit 104 so as to be driven to a predetermined focusing position by way of the AF drive portion 117 in the lens barrel 100C. The lens unit 104 is moved to a predetermined position according to the instruction (S103). This predetermined focusing position is a predetermined start position such as an infinity position.

The lens barrel 100C releases an electromagnetic lock (not illustrated) before driving the vibration reduction lens 102 (S104). The electromagnetic lock is a locking mechanism for fixing the vibration reduction lens 102 to a predetermined position. By releasing this electromagnetic lock, it becomes possible to drive the vibration reduction lens 102 by the drive power of the VCM 113.

The alignment tool 200C reads zoom information that the lens CPU 103 identifies (S203), and determines whether it is at a T end (S204). The reading of this attitude information is performed by the tool CPU 206 receiving a value of the zoom encoder 107 of the lens barrel 100C via communication from a contact point of the mounting unit 101 of the lens side. When the lens barrel 100C is not at the T end (No in S204), for example, the operator is instructed via the monitor of the tool PC 204 to move the lens barrel 100C to the T end (S205).

The lens barrel 100C starts tracking control by setting center position information that the EEPROM 116 includes to a target drive position of the vibration reduction lens 102. When moving to the center position (105), a signal indicating that alignment can be started is transmitted to the alignment tool 200C side.

The alignment tool 200C starts alignment when receiving the signal indicating that alignment can be started from the lens barrel 100C (S206). The alignment is performed at least at two positions corresponding to the focusing distance of the lens barrel 100C. In the present embodiment, the alignment is performed at three positions including a T (tele) end, a W (wide) end, and an M (middle) position.

The alignment tool 200C observes, via the monitor of the tool PC 204, an extent of aberration based on an image of light that is emitted from the light emitting unit 201, passing through the lens barrel 100C, and entering the image pickup device 202, and determines whether the aberration is within a predetermined range (S207).

In a case in which the aberration is not within a predetermined range (No in S207), the operator operates the tilt drive amount input unit 208 (S208) and drives the vibration reduction lens 102 to a best aberration position at which an aberration is minimized.

The tilt drive amount input unit 208 outputs to the lens barrel 100C side a drive amount of the vibration reduction lens 102 that is driven.

In the lens barrel 100C, the tilt drive amount information transmitted from the tool CPU 206 is converted to a position of the vibration reduction lens 102 at the tilt drive operation unit 121. Then, the vibration reduction lens 102 is driven to be tilted via the tilt drive unit 122 so as to modify a tilt position of the vibration reduction lens 102 (S106).

In a case in which the aberration is within the predetermined range (Yes in S207), a signal of an alignment correction position determination is transmitted to the lens CPU 103 (S209) side. After receiving the signal of the alignment correction position determination, the lens CPU 103 side stores the tilt position information that is an alignment position of the vibration reduction lens 102 as the best aberration position information at the T end in the RAM (not illustrated) (s107).

When adjustment at the T end ends, a similar adjustment is performed at the M position and the W end (S210). The lens CPU 103 stores tilt position information for each position as the best aberration position information in the RAM (S107).

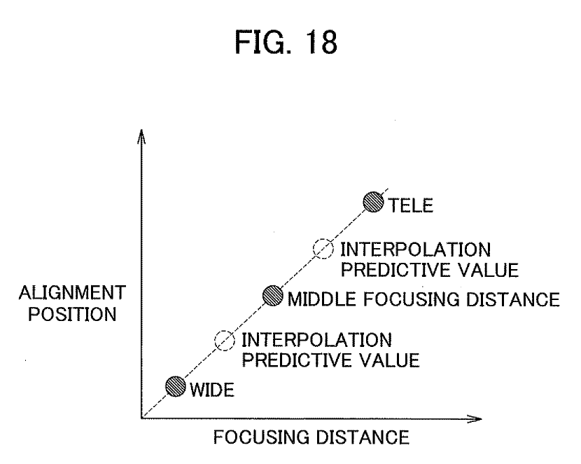

After ending the alignment (211), an end notification is transmitted to the lens CPU 103. On the lens CPU 103 side, based on the best aberration position information at the focusing distances of the three positions, best aberration position information at another zoom position is computed and interpolated so as to calculate best aberration position information according to each of the zoom positions (S108). FIG. 18 is a diagram illustrating the relationship between a focusing distance from the W end to the T end and an alignment position that is the best aberration position. In the drawing, alignment positions (black circles) when performing alignment at three positions including the T (tele) end, the W (wide) end, and the M (middle) positions. Regarding a focusing distance other than these three positions, it is possible to calculate each of the alignment positions by setting an interpolation predictive value (a dashed circle) on a line passing through the above three positions.

After completion of interpolation processing according to a zoom position of best aberration position information of the vibration reduction lens 102, the tilt position information at all of the zoom positions is stored in the EEPROM 116 as the best aberration position information of the vibration reduction lens 102 (S109). Then, the lens barrel 100C is removed from the alignment tool 200C (S110), and the alignment process ends.

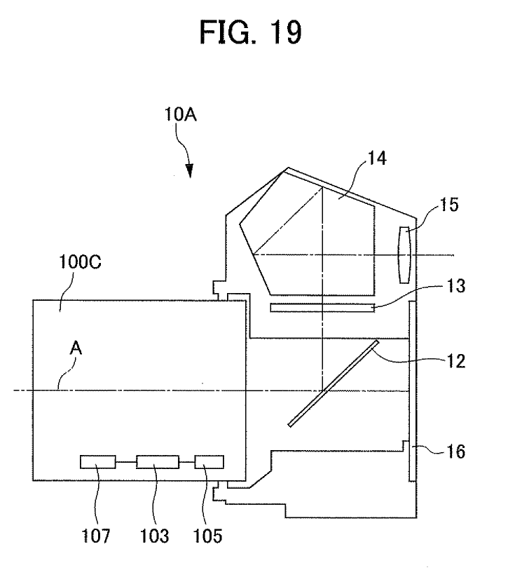

Next, aberration correction using the best aberration position information calculated in the alignment process is described. FIG. 19 is a schematic configuration of a camera 10A to which the lens barrel 100C according to the present embodiment is mounted. As shown in FIG. 19, in the camera 10A, light from an object (not illustrated) is focused at the lens barrel 100C and reflected by the quick return mirror 12 so as to provide an image to a focusing board 13. The image of the object provided to the focusing board 13 is multiply reflected by a pentaprism 14 and formed so as to be observable as an erected image by a user via an eye lens 15.

The user fully presses the shutter release button (not illustrated) after observing an image of the object via the eye lens 15 while the shutter release button is half pressed and determining a composition for photographing. When fully pressing the shutter release button, the quick return mirror 12 is upwardly sprung up, a shutter (not illustrated) operates, and light from the object is received at the image pickup device 16. Thus, an image that was captured at the image pickup device 16 is obtained, and it is stored in memory (not illustrated) after performing predetermined image processing.

In addition, when the shutter release button is half pressed, blur of the lens barrel 100C or the camera 10A is detected by the angular velocity sensor 105 embedded in the lens barrel 100C, and information thereof is transmitted to the lens CPU 103. Furthermore, zooming information of the zoom encoder 107 is transmitted to the lens CPU 103. Then, when the shutter release button is fully pressed, the lens CPU 103 corrects aberration due to image blur or the image pickup device 16 and aberration due to the eccentric element of the lens barrel 100C by driving the vibration reduction lens 102 to be shifted within a level plane that is perpendicular to the optical axis A via the VCM 113 shown in FIG. 16 and by driving the vibration reduction lens 102 about an axis that is substantially perpendicular to the optical axis A via the tilt drive unit 122.

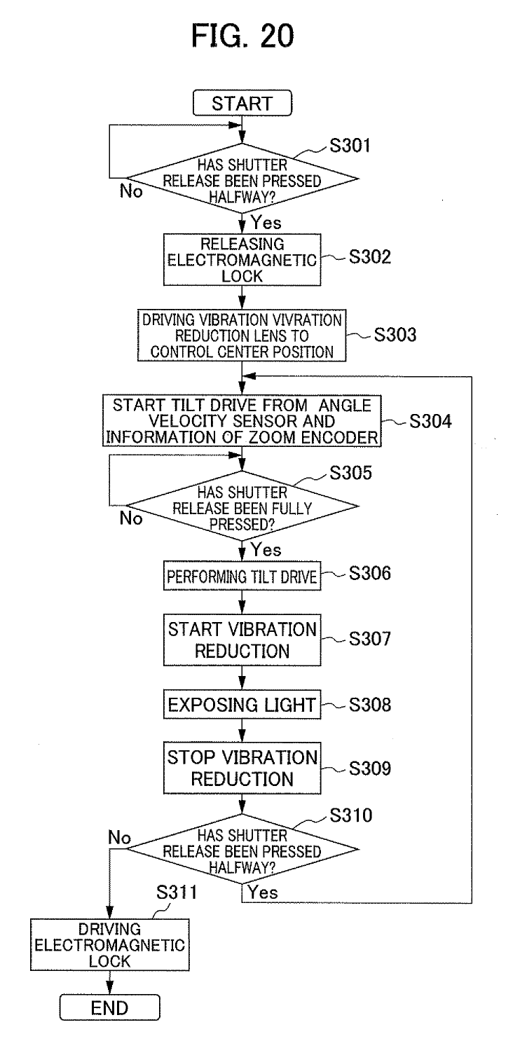

FIG. 20 is a flowchart illustrating an operating procedure of aberration correction when the vibration correction SW 115 is in an ON state. When the shutter release of the camera 10A is half pressed in a state in which the lens barrel 100C is mounted to the camera (not illustrated) (Yes in S301), supply of electric power to the vibration reduction lens 102 is started, and a vibration reduction sequence is started.

First, an electromagnetic lock that mechanically regulates the movement of the vibration reduction lens 102 is released (8302). Then, the vibration reduction lens 102 is driven to a control center position (S303). The control center position at that time is not a position of the tilt position detection unit 123, but is information from the position detection unit 114 of the vibration reduction lens 102.

Shift drive and tilt drive control of the vibration reduction lens 102 is started so that aberration on a surface of the image pickup device 16 is minimized and an image on an imaging surface is fixed based on an output of the angular velocity sensor 105 and focusing distance information of the zoom encoder 107. At this time, drive control is performed so that the vibration reduction lens 102 is placed at the best aberration position for the zoom position of the current lens barrel 100C (S304). Then, this state stands by for shutter release of a camera being fully pressed (S305).

When the shutter release of the camera 10A is pressed fully (Yes in 305), the vibration reduction lens 102 is driven to be tilted to the best aberration position based on the focusing distance information from the zoom encoder 107 while a quick return mirror (not illustrated) springs up (S306). Then, after driving for tilting to the best aberration position, vibration reduction is started again (S307).

The vibration reduction is performed, light is exposed at a predetermined shutter speed (S308) and the vibration reduction is stopped (S309). Afterward, if a half press timer is activated (Yes in S310), blur correction and tilt drive after S304 are performed; if the half press timer is deactivated (No in S310), the electromagnetic lock is driven and the operational flow ends.

In a case in which the half press timer is activated, drive for blur correction is performed; however, in a case in which the half press timer is deactivated, the electromagnetic lock is driven and the vibration reduction lens 102 is mechanically retained.

Thus, since the vibration reduction and tilt drive are performed around the best aberration position obtained in the alignment process so as to perform imaging, it becomes possible to perform imaging at the best state for aberration performance in consideration of optical performance.

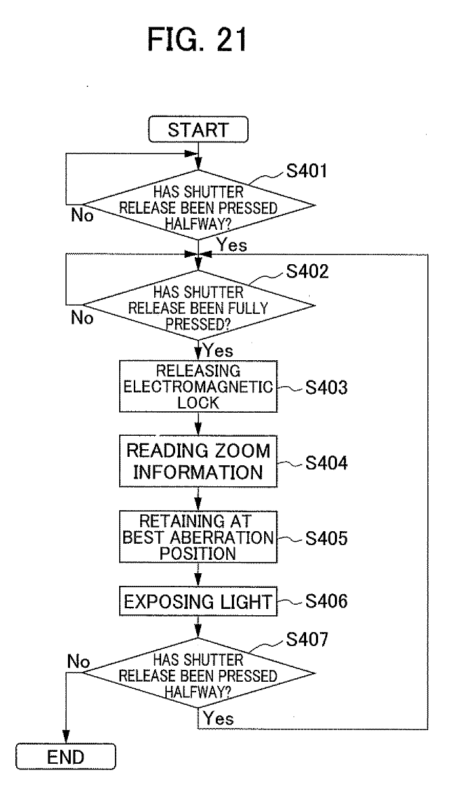

FIG. 21 is a flowchart showing an operating procedure of aberration correction when the vibration correction SW is in an OFF state. When the shutter release of a camera is half pressed (Yes in S401) and then fully pressed (Yes in S402) in a state in which the lens barrel 100C is mounted to a camera, a quick return mirror (not illustrated) springs up and the electromagnetic lock is released (S403).

Then, zoom information of the current lens barrel 100C is read by the lens CPU 103 (S404). Then, the vibration reduction lens 102 is driven to be tilted to the best aberration position for the zoom position of the current lens barrel 100C (S405). Similarly to the abovementioned case of the vibration reduction SW115 being in the ON state, this best aberration position differs depending on a value of the zoom encoder 107, and the best aberration positions for the T end, the M position, and the W end are the positions obtained by the alignment in S204 to S214 of FIG. 17. Positions therebetween are positions that are computed and interpolated in S108 of FIG. 17. Then, after light is exposed at a predetermined shutter speed (S406), the electromagnetic lock is driven (S407), and the operational flow ends.

Thus, even when the vibration reduction SW 115 is in an OFF state, since imaging is performed at the best aberration position by the tilt correction obtained in the alignment process, it becomes possible to perform imaging at the best position for aberration performance in consideration of optical performance.

According to the above fourth embodiment, the present embodiment has the following effects.

1) The position of the vibration reduction lens 102 at which aberration generated on the imaging surface by the imaging optical system composed of a plurality of the lens unit 104 included in the lens barrel 100C is minimized is stored as a best aberration position that corresponds to a focusing distance for each of the individual lens barrel 100C. At the time of imaging, imaging is performed after the vibration reduction lens 102 is moved to the best aberration position at the focusing distance. In this way, since aberration differing depending on the lens barrels 100C are adjusted for each lens barrel 100C, the aberration of each lens barrel can be minimized.

(2) Furthermore, since the best aberration position fluctuates so that aberration is minimized according to the focusing distances, it becomes possible to perform imaging at the best position for aberration performance in consideration of optical performance at each of the focusing distances.

(3) Since the current vibration reduction lens 102 is used, it is not necessary to newly add a component for aberration correction.

4) Since vibration reduction is performed around the best aberration position, it is possible to perform quick vibration correction.

(5) In a case in which the lens that corrects aberration is the vibration reduction lens 102, the vibration reduction lens 102 may be drawn back (centering) to an inclined position stored in a storage unit at which aberration is made small. This is because it is possible to perform imaging in a better state of optical characteristics by drawing back the vibration reduction lens 102 to an inclined position at which aberration is made small. Furthermore, by drawing back the vibration reduction lens to an inclined position at which aberration is made small, a drive range in which the vibration reduction lens 102 can be driven to be tilted can be made substantially large.

Drawing back of the vibration reduction lens 102 may be performed before imaging by the imaging unit (before exposing light) and may be performed during imaging by the imaging unit (while exposing light). Furthermore, the vibration reduction lens 102 is not limited to one that is substantially perpendicular to the optical axis A.

### Fifth Embodiment

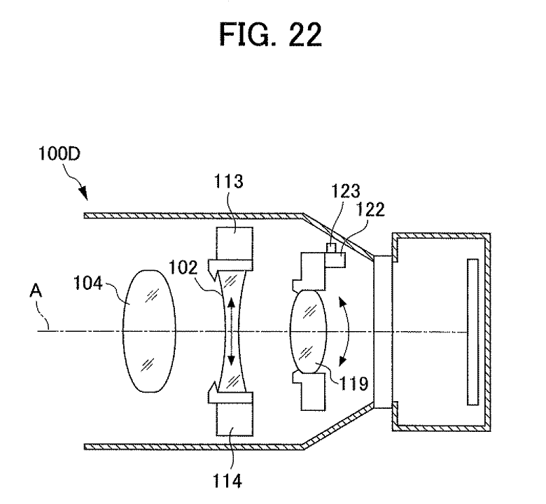

In the above fourth embodiment, although an example in which the lens for correcting aberration is the vibration correction lens 102 is exemplified, a lens other than the vibration reduction lens 102 may be used for correcting aberration. FIG. 22 shows a configuration of a case in which aberration is corrected by a lens 119 that is disposed at a subsequent stage to the vibration reduction lens 102. FIG. 22 shows a part of the lens barrel 100D and an alignment tool, and portions equivalent to the fourth embodiment are assigned the same reference numerals and described. Furthermore, illustrations of another configuration, connection path, and the like are omitted in this embodiment as well as subsequent embodiments.

The vibration reduction lens 102 according to the present embodiment includes a VCM 113 that drives the vibration reduction lens 102 to be shifted within a level plane that is perpendicular to the optical axis A and a position detection unit 114 that detects a position of the vibration reduction lens 102 within the level plane that is perpendicular to the optical axis A. Furthermore, the lens 119 disposed at a subsequent stage of the vibration reduction lens 102 includes a tilt drive unit 122 that causes the lens 119 to be tilted about an axis that is substantially perpendicular to the optical axis A, and a tilt position detection unit 123 for detecting a position of the tilt drive unit 122.

According to the lens barrel 100D of the present embodiment, vibration reduction is performed by shift drive of the vibration reduction lens 102, and aberration correction is performed by tilt drive of the lens 119. Thus, even in a case in which aberration is corrected using a lens other than the vibration reduction lens 102, similar effects to the fourth embodiment can be obtained. In the configuration of the present embodiment, it is also preferable that aberration is corrected by driving the lens 119, which corrects aberration before exposure, to be tilted, and that drive of the lens 119 that corrects aberration is stopped during light exposure. In this case, since the lens 119 that corrects aberration is stopped during exposure, unwanted image blur can be suppressed.

In the configuration of the fifth embodiment, the lens barrel 100D shown in FIG. 22 has a similar configuration to the first embodiment as described above such as the zoom encoder 107 (see FIG. 2) for detecting a focusing distance, EEPROM 116 (see FIG. 2), and the like. The lens barrel 100D can perform aberration correction similarly to the first embodiment described above by driving the lens 119 to be tilted based on zoom information detected by the zoom encoder 107 using the tilt drive unit 122.

Furthermore, in the configuration of the fifth embodiment, it may be a configuration in which an attitude sensor (not illustrated) for detecting an attitude of the lens barrel 100D is included (illustration thereof is omitted). In this case, aberration correction can be performed by driving the lens 119 to be tilted based on attitude information detected by the attitude sensor and position information of the vibration reduction lens 102 at the tilt drive unit 122.

### Sixth Embodiment

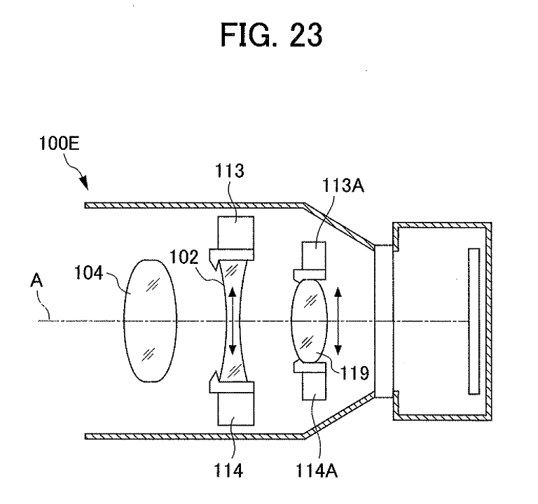

In the above fifth embodiment, aberration may be corrected by driving the lens 119 disposed at a subsequent stage of the vibration reduction lens 102 to be shifted. FIG. 23 illustrates a configuration in a case in which aberration is corrected by a lens 119 that is disposed at a subsequent stage to the vibration reduction lens 102.

The vibration reduction lens 102 according to the present embodiment includes a VCM 113 that drives the vibration reduction lens 102 to be shifted with a level plane that is perpendicular to the optical axis A, and a position detection unit 114 that detects a position of the vibration reduction lens 102 within the level plane that is perpendicular to the optical axis A. Furthermore, the lens 119 disposed at a subsequent stage of the vibration reduction lens 102 includes a VCM 113A that drives the lens 119 to be shifted within a level plane that is perpendicular to the optical axis A, and a position detection unit 114A that detects a position within the level plane that is perpendicular to the optical axis A of the lens 119.

In the configuration of the sixth embodiment, the lens barrel 100E shown in FIG. 23 has a similar configuration to the first embodiment as described above such as the zoom encoder 107 (see FIG. 2) for detecting a focusing distance, EEPROM 116 (see FIG. 2), and the like. The lens barrel 100E can perform aberration correction similarly to the first embodiment described above by driving the lens 119 to be shifted based on zoom information detected by the zoom encoder 107 using the shift drive unit 113.

According to the lens barrel 100E of the present embodiment, vibration reduction is performed by the shift drive of the vibration reduction lens 102 and aberration correction is performed by the shift drive of the lens 119. Thus, even in a case of correcting aberration by driving a lens other than the vibration reduction lens 102 to be shifted, similar effects to the first embodiment can be obtained.

Furthermore, in the configuration of the sixth embodiment, it may be a configuration in which an attitude sensor (not illustrated) for detecting an attitude of the lens barrel 100E is included (illustration thereof is omitted). In this case, aberration correction can be performed by driving the lens 119 to be shifted based on attitude information detected by the attitude sensor and position information of the vibration reduction lens 102 at a VCM drive driver (not illustrated) that drives the VCM 113A.

### Seventh Embodiment

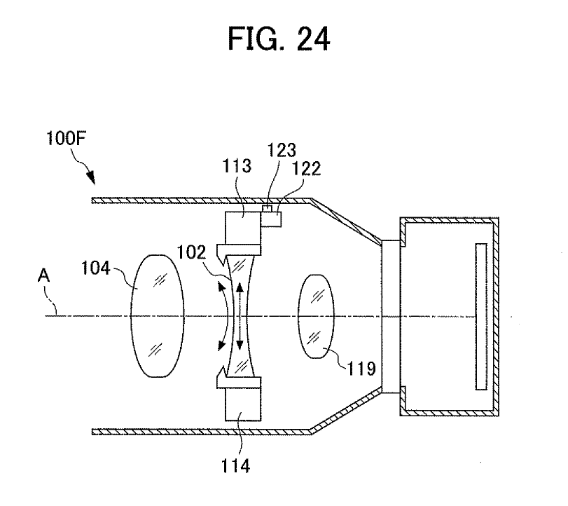

In the configuration of the present invention, vibration reduction may be performed by driving the vibration reduction lens 102 to be tilted about an axis that is substantially perpendicular to the optical axis A. FIG. 24 shows a configuration of a case in which vibration reduction is performed by driving the vibration correction lens 102 to be tilted and aberration correction is performed by driving it to be shifted. A basic configuration of the lens barrel 100F shown in FIG. 24 is similar to that in FIG. 16; however, a function of the vibration reduction lens 102 is different from that in FIG. 16, which is indicated by an arrow.

The vibration reduction lens 102 according to the present embodiment includes VCM 113 that drives the vibration reduction lens 102 to be shifted in a level plane that is perpendicular to the optical axis A and a position detection unit 114 that detect a position of the vibration reduction lens 102 in a level plane that is substantially perpendicular to the optical axis A. Furthermore, the vibration reduction lens 102 includes a tilt drive unit 122 that causes the vibration reduction lens 102 to be tilted about an axis that is substantially perpendicular to the optical axis A, and a tilt position detection unit 123 for detecting a position of the tilt driving unit 122.

According to the lens barrel 100F of the seventh embodiment, vibration reduction is performed by tilt drive of the vibration reduction lens 102, and aberration correction is performed by shift drive of the lens 102. Thus, even in a case in which vibration reduction is performed by driving the vibration reduction lens 102 to be tilted and aberration is corrected by driving it to be shifted, similar effects to the fourth embodiment can be obtained.

In the configuration of the seventh embodiment, the lens barrel 100F shown in FIG. 24 has a similar configuration to the first embodiment as described above such as the zoom encoder 107 (see FIG. 2) for detecting a focusing distance, EEPROM 116 (see FIG. 2), and the like. The lens barrel 100F can perform aberration correction similarly to the first embodiment described above by driving the lens 102 to be shifted based on zoom information detected by the zoom encoder 107 using the shift drive unit 113.

Furthermore, in the configuration of the seventh embodiment, it may be a configuration in which an attitude sensor (not illustrated) for detecting an attitude of the lens barrel 100F is included (illustration thereof is omitted). In this case, aberration correction can be performed by driving the vibration reduction lens 102 to be shifted based on attitude information detected by the attitude sensor and position information of the vibration reduction lens 102 at a VCM drive driver (not illustrated) that drives the VCM 113A.

### Eighth Embodiment

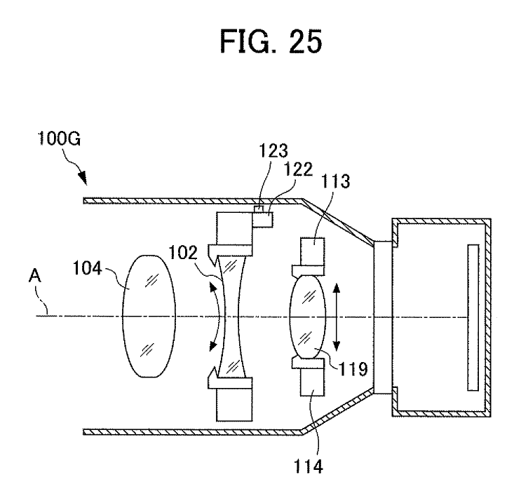

In the above seventh embodiment, aberration may be corrected by driving the lens 119 disposed at a subsequent stage of the vibration reduction lens 102 to be shifted. FIG. 25 illustrates a configuration of a case in which aberration is corrected by a lens 119 that is disposed at a subsequent stage to the vibration reduction lens 102.

The vibration reduction lens 102 according to the present embodiment includes a tilt drive unit 122 that causes the vibration reduction lens 102 to be tilted about an axis that is substantially perpendicular to the optical axis A, and a tilt position detection unit 123 for detecting a position of the tilt drive unit 122. Furthermore, the lens 119 disposed at a subsequent stage of the vibration reduction lens 102 includes a VCM 113 that drives the lens 119 to be shifted within a level plane that is perpendicular to the optical axis A, and a position detection unit 114 that detects a position within the level plane that is substantially perpendicular to the optical axis A of the lens 119.

In the configuration of the eighth embodiment, the lens barrel 100G shown in FIG. 25 includes a similar configuration to the first embodiment as described above such as the zoom encoder 107 (see FIG. 2) for detecting a focusing distance, EEPROM 116 (see FIG. 2), and the like. The lens barrel 100G can perform aberration correction similarly to the first embodiment described above by driving the lens 119 to be shifted based on zoom information detected by the zoom encoder 107 using the shift drive unit 113.

According to the lens barrel 100G of the eighth embodiment, vibration reduction is performed by the tilt drive of the vibration reduction lens 102 and aberration correction is performed by the shift drive of the lens 119. Thus, even in a case of correcting aberration by driving a lens other than the vibration reduction lens 102 to be shifted, similar effects to the fourth embodiment can be obtained.

Furthermore, in the configuration of the eighth embodiment, it may be a configuration in which an attitude sensor (not illustrated) for detecting an attitude of the lens barrel 100G is included (illustration thereof is omitted). In this case, aberration correction can be performed by driving the lens 119 to be shifted based on attitude information detected by the attitude sensor and position information of the vibration reduction lens 102 at a VCM drive driver (not illustrated) that drives the VCM 113A.

### Ninth Embodiment

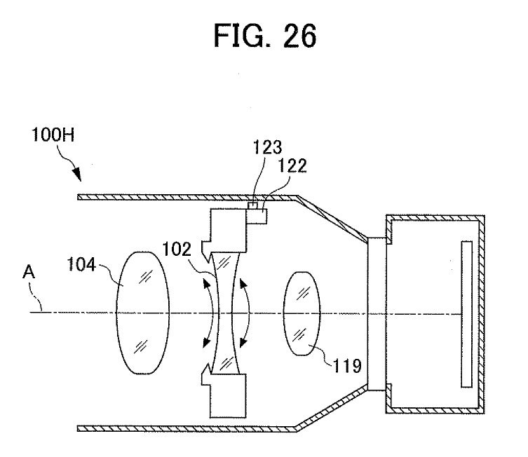

In a configuration of the present invention, vibration reduction and aberration correction may be performed by driving the vibration reduction lens 102 to be tilted about an axis that is substantially perpendicular to the optical axis A. FIG. 26 shows a configuration of a case in which vibration reduction and aberration correction is performed by driving the vibration correction lens 102 to be tilted. The basic configuration of the lens barrel 100H shown in FIG. 26 is similar to that in FIG. 16; however, the function of the vibration reduction lens 102 is different from that in FIG. 16, which is indicated by an arrow.

The vibration reduction lens 102 according to the present embodiment includes a tilt drive unit 122 that causes the vibration reduction lens 102 to be tilted about an axis that is substantially perpendicular to the optical axis A and a tilt position detection unit 123 for detecting a position of the tilt driving unit 122.

In the configuration of the ninth embodiment, the lens barrel 100H shown in FIG. 26 has a similar configuration to the first embodiment as described above such as the zoom encoder 107 (see FIG. 2) for detecting a focusing distance, EEPROM 116 (see FIG. 2), and the like. The lens barrel 100H can perform aberration correction similarly to the first embodiment described above by driving the lens 102 to be tilted based on zoom information detected by the zoom encoder 107 using the tilt drive unit 122.

According to the lens barrel 100H of the ninth embodiment, vibration reduction is performed by tilt drive of the vibration reduction lens 102, and aberration correction is performed by tilt drive of the lens 102. Thus, even in a case in which aberration correction and vibration reduction are performed by driving the vibration reduction lens 102 to be tilted, similar effects to the fourth embodiment can be obtained.

Furthermore, in the configuration of the ninth embodiment, it may be a configuration in which an attitude sensor (not illustrated) for detecting an attitude of the lens barrel 100H is included (illustration thereof is omitted). In this case, aberration correction can be performed by driving the vibration reduction lens 102 to be tilted based on attitude information detected by the attitude sensor and position information of the vibration reduction lens 102 at the tilt drive unit 122.

### Tenth Embodiment

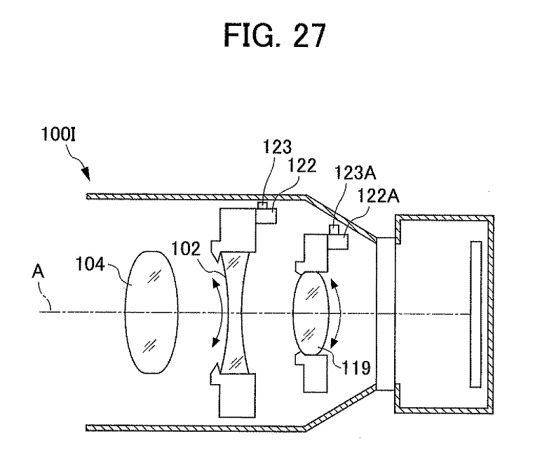

In the configuration of the above ninth embodiment, aberration correction may be performed by driving the lens 119 disposed at a subsequent stage of the vibration reduction lens 102 to be tilted. FIG. 27 shows a configuration of a case in which aberration is corrected by a lens 119 that is disposed at a subsequent stage to the vibration reduction lens 102.

The vibration reduction lens 102 according to the present embodiment includes a tilt drive unit 122 that causes the vibration reduction lens 102 to be tilted about an axis that is substantially perpendicular to the optical axis A and a tilt position detection unit 123 for detecting a position of the tilt drive unit 122. Furthermore, the lens 119 disposed at a subsequent stage of the vibration reduction lens 102 includes a tilt drive unit 122A that causes the lens 119 to be tilted about an axis that is substantially perpendicular to the optical axis A and a tilt position detection unit 123A for detecting a position of the tilt drive unit 122A.

In the configuration of the tenth embodiment, the lens barrel 100I shown in FIG. 27 has a similar configuration to the first embodiment as described above such as the zoom encoder 107 (see FIG. 2) for detecting a focusing distance, EEPROM 116 (see FIG. 2), and the like. The lens barrel 100I can perform aberration correction similarly to the first embodiment described above by driving the lens 119 to be tilted based on zoom information detected by the zoom encoder 107 using the tilt drive unit 122A.

According to the lens barrel 100I of the tenth embodiment, vibration reduction is performed by the tilt drive of the vibration reduction lens 102 and aberration correction is performed by the tilt drive of the lens 119. Thus, even in a case of correcting aberration by driving a lens other than the vibration reduction lens 102 to be tilted, similar effects to the fourth embodiment can be obtained.

Furthermore, in the configuration of the tenth embodiment, it may be a configuration in which an attitude sensor (not illustrated) for detecting an attitude of the lens barrel 100I is included (illustration thereof is omitted). In this case, aberration correction can be performed by driving the lens 119 to be tilted based on attitude information detected by the attitude sensor and position information of the vibration reduction lens 102 at the tilt drive unit 122A.

### Modified Embodiment

Without being limited to the fourth embodiment to the tenth embodiment as described above, various changes and modifications to the present invention as shown below can be made, and these are also within the scope of the present invention.

1) Although the abovementioned fourth embodiment is configured in a structure in which the alignment tool 200C is mounted to the lens barrel 100, the present invention is not limited thereto.

For example, it may be a structure in which the camera has a function of the alignment tool 200C. In this case, the image pickup device 202 of the alignment tool can be used as the image pickup device of the camera.

2) Although the abovementioned fourth embodiment is described so that an operator operates the tilt drive amount input unit 208 so as to drive the vibration reduction lens 102 to be tilted to the best aberration position at which aberration is minimized, the present invention is not limited thereto. For example, it may be configured so that the tool CPU 206 drives the vibration reduction lens 102 to the best aberration position automatically.

(3) In the abovementioned fourth embodiment, although measurement of alignment is performed at the T end, the M position, and the W end, the present invention is not limited thereto.

It is possible to correct aberration with higher accuracy by performing measurement at least at three positions.

Furthermore, in a case in which aberration is approximately within an acceptable range at the entire zoom region and aberration is significantly large in a specific position, it may be configured to perform measurement of alignment solely at the position.

(4) The embodiments of the imaging device according to the present invention are not limited to the embodiment of the fourth embodiment to the tenth embodiment as described above, and include general optical apparatuses including an imaging optical system such as a lens barrel, a camera body, a still camera, a video camera, a camera-equipped cell phone, and the like.

Furthermore, the abovementioned fourth embodiment to the tenth embodiment and the modified embodiment can be combined appropriately to be used; however, a detailed explanation thereof is omitted since the configuration of each embodiment is apparent in view of the drawings and the descriptions. In addition, the present invention is not limited to the embodiments described above.

1.-36. (canceled)

37. A lens barrel comprising:
an imaging optical system having a second optical system that can be moved relative to a first optical system; and
drive unit that causes the second optical system to be driven relative to the first optical system so that aberration of the imaging optical system is reduced, after detecting a focusing distance of the imaging optical system and before capturing an image by way of the imaging optical system, wherein the drive unit drives the second optical system so as to be inclined relative to the first optical system.

38. The lens barrel according to claim 37, wherein:
the second optical system is an eccentric lens.

39. The lens barrel according to claim 37, wherein:
the second optical system is a vibration reduction lens that corrects blur of an image.

40. The lens barrel according to claim 39, wherein:
the drive unit imparts drive power to the vibration reduction lens for drawing back thereof to a position at which aberration amount of the imaging optical system is suppressed, while the vibration reduction lens corrects blur of the image.

41. The lens barrel according to claim 37, comprising:
a storage unit that can store position information of the second optical system in which an aberration amount of the imaging optical system is suppressed, wherein:
the drive unit drives the second optical system based on position information stored in the storage unit.

42. The lens barrel according to claim 41, wherein:
the storage unit stores position information of the second optical system according to a focusing distance of the imaging optical system, and wherein:
the drive unit drives the second optical system based on information of the focusing distance and the position information stored in the storage unit.

43. The lens barrel according to claim 41, wherein:
the storage unit stores the position information of the second optical system according to an attitude at the time of image capturing, and wherein:
the drive unit drives the second optical system based on information of an attitude at the time of the image capturing and the position information stored in the storage unit.

44. The lens barrel according to claim 39, comprising:
a blur detection unit that detects blur of an apparatus, wherein:
the drive unit drives the vibration reduction lens so as to correct the blur according to an output of the blur detection unit.

45. The lens barrel according to claim 44, wherein:
the drive unit corrects blur of the image by driving the vibration reduction lens in a direction that intersects with an optical axis of the imaging optical system, according to an output of the blur detection unit.

46. The lens barrel according to claim 44, wherein:
the drive unit corrects blur of the image by driving the vibration reduction lens so as to be inclined relative to the first optical system, according to an output of the blur detection unit.

47. The lens barrel according to claim 37, comprising:
a vibration reduction lens that is provided independently from the second optical system and corrects blur of an image.

48. The lens barrel according to claim 37, wherein:
the drive unit drives the second optical system before an image is captured by the imaging optical system, and does not drive the second optical system while the image is captured.

49. A lens barrel comprising:
an imaging optical system having a second optical system that can be moved relative to a first optical system; and
a drive unit that causes the second optical system to be driven relative to the first optical system so that aberration of the imaging optical system is reduced, after detecting an attitude at the time of image capturing and before capturing an image by way of the imaging optical system wherein the drive unit drives the second optical system so as to be inclined relative to the first optical system.

50. The lens barrel according to claim 49, wherein:
the second optical system is an eccentric lens.

51. The lens barrel according to claim 49, wherein:
the second optical system is a vibration reduction lens that corrects blur of an image.

52. A lens barrel comprising:
an imaging optical system having a second optical system that can be moved relative to a first optical system; and
drive unit that causes the second optical system to be driven relative to the first optical system so that aberration of the imaging optical system is reduced, after detecting a focusing distance of the imaging optical system and before capturing an image by way of the imaging optical system, wherein
the drive unit drives the second optical system in a direction that intersects with an optical axis of the imaging optical system.

53. The lens barrel according to claim 52, wherein:
the second optical system is an eccentric lens.

54. A lens barrel comprising:
an imaging optical system having a second optical system that can be moved relative to a first optical system; and
a drive unit that causes the second optical system to be driven relative to the first optical system so that aberration of the imaging optical system is reduced, after detecting an attitude at the time of image capturing and before capturing an image by way of the imaging optical system, wherein
the drive unit drives the second optical system in a direction that intersects with an optical axis of the imaging optical system.

55. The lens barrel according to claim 54, wherein:
the second optical system is an eccentric lens.

56. An imaging apparatus comprising:
a lens barrel according to claim 37; and
an imaging unit that captures an image by way of the imaging optical system.
